(19) United States
(12) Patent Application Publication
(10) Pub. No.: US 2026/0106711 A1
(43) Pub. Date: Apr. 16, 2026

(54) INTERLACED SUB-REG BUNDLES IN NESTED SEARCH SPACE FOR PDCCH DMRS SHARING

(71) Applicant: QUALCOMM Incorporated, San Diego, CA (US)

(72) Inventors: Chih-Hao LIU, San Diego, CA (US); Jing SUN, San Diego, CA (US); Morteza SOLTANI, San Diego, CA (US); Jing JIANG, San Diego, CA (US); Tingfang JI, San Diego, CA (US)

(21) Appl. No.: 18/915,079

(22) Filed: Oct. 14, 2024

(51) Int. Cl. H04L 5/00; H04W 72/232

(52) U.S. Cl. CPC H04L 5/005; H04L 5/0053; H04W 72/232

(57) ABSTRACT

Methods, systems, and devices for wireless communications are described. A user equipment (UE) may receive control channel configuration information indicating a sub-resource element group (sub-REG) bundle interlaced search space associated with an interlaced physical downlink control channel (PDCCH) candidate set. The control channel configuration information may also provide an indication of reference signal sharing across a plurality of PDCCHs associated with the interlaced PDCCH candidate set. The UE may monitor the interlaced PDCCH candidate set for a PDCCH, of the plurality of PDCCHs, that is targeted for the UE. The UE may receive a control message via the sub-REG bundle interlaced search space and the target PDCCH.

### FIELD OF TECHNOLOGY

The following relates to wireless communications, including interlaced sub-resource element group (sub-REG) bundles in nested search spaces for physical downlink control channel (PDCCH) demodulation reference signal (DMRS) sharing.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control channel configuration information indicating: a sub-resource element group (sub-REG) bundle interlaced search space associated with an interlaced physical downlink control channel (PDCCH) candidate set, and reference signal sharing across a set of multiple PDCCHs associated with the interlaced PDCCH candidate set, monitoring, based on the control channel configuration information, the interlaced PDCCH candidate set for a target PDCCH, of the set of multiple PDCCHs, that is associated with the UE, and receiving, via the sub-REG bundle interlaced search space and the target PDCCH, a control message.

A UE for wireless communications is described. The UE may include one or more memories storing processor executable code, and one or more processors coupled with the one or more memories. The one or more processors may individually or collectively be operable to execute the code to cause the UE to receive control channel configuration information indicating: a sub-REG bundle interlaced search space associated with an interlaced PDCCH candidate set, and reference signal sharing across a set of multiple PDCCHs associated with the interlaced PDCCH candidate set, monitor, based on the control channel configuration information, the interlaced PDCCH candidate set for a target PDCCH, of the set of multiple PDCCHs, that is associated with the UE, and receive, via the sub-REG bundle interlaced search space and the target PDCCH, a control message.

Another UE for wireless communications is described. The UE may include means for receiving control channel configuration information indicating: a sub-REG bundle interlaced search space associated with an interlaced PDCCH candidate set, and reference signal sharing across a set of multiple PDCCHs associated with the interlaced PDCCH candidate set, means for monitoring, based on the control channel configuration information, the interlaced PDCCH candidate set for a target PDCCH, of the set of multiple PDCCHs, that is associated with the UE, and means for receiving, via the sub-REG bundle interlaced search space and the target PDCCH, a control message.

A non-transitory computer-readable medium storing code for wireless communications is described. The code may include instructions executable by one or more processors to receive control channel configuration information indicating: a sub-REG bundle interlaced search space associated with an interlaced PDCCH candidate set, and reference signal sharing across a set of multiple PDCCHs associated with the interlaced PDCCH candidate set, monitor, based on the control channel configuration information, the interlaced PDCCH candidate set for a target PDCCH, of the set of multiple PDCCHs, that is associated with the UE, and receive, via the sub-REG bundle interlaced search space and the target PDCCH, a control message.

In some examples of the method, UEs, and non-transitory computer-readable medium described herein, the sub-REG bundle interlaced search space may be based on a partition of each initial REG bundle, of a set of multiple initial REG bundles of an initial search space associated with an initial PDCCH candidate set, into a set of multiple respective sub-REG bundles that may be spread in a frequency domain across the set of multiple initial REG bundles.

In some examples of the method, UEs, and non-transitory computer-readable medium described herein, the initial search space includes a virtual search space.

In some examples of the method, UEs, and non-transitory computer-readable medium described herein, the control channel configuration information further indicates a spreading factor indicating a quantity of sub-REG bundles into which each initial REG bundle may be partitioned.

In some examples of the method, UEs, and non-transitory computer-readable medium described herein, a first subset of PDCCHs of the set of multiple PDCCHs share a common DMRS sequence associated with a shared DMRS, the first subset of PDCCHs may be associated with a first initial REG bundle of the set of multiple initial REG bundles, and the shared DMRS may be embedded within one or more PDCCHs of the first subset of PDCCHs.

In some examples of the method, UEs, and non-transitory computer-readable medium described herein, monitoring the interlaced PDCCH candidate set for the target PDCCH may include operations, features, means, or instructions for performing, based on the initial search space and the sub-REG bundle interlaced search space at least partially overlapping, blind decoding of the initial PDCCH candidate set for the target PDCCH, performing, based on detection of a shared DMRS during the blind decoding of the initial PDCCH candidate set, channel estimation, where the shared DMRS may be embedded in the target PDCCH, and performing, based on the channel estimation, blind decoding of the interlaced PDCCH candidate set for the target PDCCH.

In some examples of the method, UEs, and non-transitory computer-readable medium described herein, the sub-REG bundle interlaced search space may be based on a partition of each initial REG bundle, of a set of multiple initial REG bundles associated with respective control channel elements (CCEs) of an initial PDCCH candidate of a set of multiple PDCCH candidates of an initial search space associated with an initial PDCCH candidate set, into a set of multiple respective sub-REG bundles that may be spread in a frequency domain across the set of multiple initial REG bundles.

In some examples of the method, UEs, and non-transitory computer-readable medium described herein, the sub-REG bundle interlaced search space may be based on a partition of each initial REG bundle, of a set of multiple initial REG bundles, into a set of multiple respective sub-REG bundles, a resource block (RB) cyclic shift may be associated with one or more sub-REG bundles of the set of multiple respective sub-REG bundles, and different initial REG bundles may be associated with different RB cyclic shifts.

In some examples of the method, UEs, and non-transitory computer-readable medium described herein, one or more other PDCCHs, of the set of multiple PDCCHs, may be included in a same REG bundle as the target PDCCH in the sub-REG bundle interlaced search space.

Some examples of the method, UEs, and non-transitory computer-readable medium described herein may further include operations, features, means, or instructions for detecting, based at least on one or more sub-REG bundles of the same REG bundle monitored as the target PDCCH, a shared DMRS transmitted by at least one of the one or more other PDCCHs and performing, based on detection of the shared DMRS, channel estimation.

A method for wireless communications by a network entity is described. The method may include transmitting control channel configuration information indicating a sub-REG bundle interlaced search space associated with an interlaced PDCCH candidate set and indicating reference signal sharing across a set of multiple PDCCHs associated with the interlaced PDCCH candidate set, where the set of multiple PDCCHs are associated with a set of multiple UEs and transmitting, based on the control channel configuration information, one or more control messages via the set of multiple PDCCHs within the interlaced PDCCH candidate set.

A network entity for wireless communications is described. The network entity may include one or more memories storing processor executable code, and one or more processors coupled with the one or more memories. The one or more processors may individually or collectively be operable to execute the code to cause the network entity to transmit control channel configuration information indicating a sub-REG bundle interlaced search space associated with an interlaced PDCCH candidate set and indicating reference signal sharing across a set of multiple PDCCHs associated with the interlaced PDCCH candidate set, where the set of multiple PDCCHs are associated with a set of multiple UEs and transmit, based on the control channel configuration information, one or more control messages via the set of multiple PDCCHs within the interlaced PDCCH candidate set.

Another network entity for wireless communications is described. The network entity may include means for transmitting control channel configuration information indicating a sub-REG bundle interlaced search space associated with an interlaced PDCCH candidate set and indicating reference signal sharing across a set of multiple PDCCHs associated with the interlaced PDCCH candidate set, where the set of multiple PDCCHs are associated with a set of multiple UEs and means for transmitting, based on the control channel configuration information, one or more control messages via the set of multiple PDCCHs within the interlaced PDCCH candidate set.

A non-transitory computer-readable medium storing code for wireless communications is described. The code may include instructions executable by one or more processors to transmit control channel configuration information indicating a sub-REG bundle interlaced search space associated with an interlaced PDCCH candidate set and indicating reference signal sharing across a set of multiple PDCCHs associated with the interlaced PDCCH candidate set, where the set of multiple PDCCHs are associated with a set of multiple UEs and transmit, based on the control channel configuration information, one or more control messages via the set of multiple PDCCHs within the interlaced PDCCH candidate set.

In some examples of the method, network entities, and non-transitory computer-readable medium described herein, an initial search space may be associated with an initial PDCCH candidate set and includes a set of multiple initial REG bundles and the sub-REG bundle interlaced search space may be based on a partition of each initial REG bundle, of the set of multiple initial REG bundles, into a set of multiple respective sub-REG bundles that may be spread in a frequency domain across the set of multiple initial REG bundles.

In some examples of the method, network entities, and non-transitory computer-readable medium described herein, the initial search space includes a virtual search space.

In some examples of the method, network entities, and non-transitory computer-readable medium described herein, the control channel configuration information further indicates a spreading factor indicating a quantity of sub-REG bundles into which each initial REG bundle may be partitioned.

Some examples of the method, network entities, and non-transitory computer-readable medium described herein may further include operations, features, means, or instructions for transmitting a shared DMRS associated with one or more PDCCHs of a first subset of PDCCHs of the set of multiple PDCCHs, where the first subset of PDCCHs may be associated with a first initial REG bundle of the set of multiple initial REG bundles and share a common DMRS sequence associated with the shared DMRS.

In some examples of the method, network entities, and non-transitory computer-readable medium described herein, the control channel configuration information further indicates the initial search space and the initial search space and the sub-REG bundle interlaced search space at least partially overlap.

In some examples of the method, network entities, and non-transitory computer-readable medium described herein, an initial search space may be associated with an initial PDCCH candidate set and includes a set of multiple initial REG bundles associated with respective CCEs of an initial original PDCCH candidate of a set of multiple PDCCH candidates and the sub-REG bundle interlaced search space may be based on a partition of each initial REG bundle, of the set of multiple initial REG bundles, into a set of multiple respective sub-REG bundles that may be spread in a frequency domain across the set of multiple initial REG bundles.

In some examples of the method, network entities, and non-transitory computer-readable medium described herein, an initial search space may be associated with an initial PDCCH candidate set and includes a set of multiple initial REG bundles, the sub-REG bundle interlaced search space may be based on a partition of each initial REG bundle, of the set of multiple initial REG bundles, into a set of multiple respective sub-REG bundles, an RB cyclic shift may be associated with one or more sub-REG bundles of the set of multiple respective sub-REG bundles, and different initial REG bundles may be associated with different RB cyclic shifts.

In some examples of the method, network entities, and non-transitory computer-readable medium described herein, each of the set of multiple PDCCHs may be included in one or more sub-REG bundles of a same REG bundle in the sub-REG bundle interlaced search space.

In some examples of the method, network entities, and non-transitory computer-readable medium described herein, each of the set of multiple PDCCHs may be included in different REG bundles in the sub-REG bundle interlaced search space.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports interlaced sub-resource element group (sub-REG) bundles in nested search spaces for physical downlink control channel (PDCCH) demodulation reference signal (DMRS) sharing in accordance with one or more aspects of the present disclosure.

FIG. 2 shows an example of a portion of a wireless communications system that supports interlaced sub-REG bundles in nested search spaces for PDCCH DMRS sharing in accordance with one or more aspects of the present disclosure.

FIGS. 3 to 6 show examples of control channel configurations that support interlaced sub-REG bundles in nested search spaces for PDCCH DMRS sharing in accordance with one or more aspects of the present disclosure.

FIGS. 7 and 8 show block diagrams of devices that support interlaced sub-REG bundles in nested search spaces for PDCCH DMRS sharing in accordance with one or more aspects of the present disclosure.

FIG. 9 shows a block diagram of a communications manager that supports interlaced sub-REG bundles in nested search spaces for PDCCH DMRS sharing in accordance with one or more aspects of the present disclosure.

FIG. 10 shows a diagram of a system including a device that supports interlaced sub-REG bundles in nested search spaces for PDCCH DMRS sharing in accordance with one or more aspects of the present disclosure.

FIGS. 11 and 12 show block diagrams of devices that support interlaced sub-REG bundles in nested search spaces for PDCCH DMRS sharing in accordance with one or more aspects of the present disclosure.

FIG. 13 shows a block diagram of a communications manager that supports interlaced sub-REG bundles in nested search spaces for PDCCH DMRS sharing in accordance with one or more aspects of the present disclosure.

FIG. 14 shows a diagram of a system including a device that supports interlaced sub-REG bundles in nested search spaces for PDCCH DMRS sharing in accordance with one or more aspects of the present disclosure.

FIGS. 15 through 18 show flowcharts illustrating methods that support interlaced sub-REG bundles in nested search spaces for PDCCH DMRS sharing in accordance with one or more aspects of the present disclosure.

### DETAILED DESCRIPTION

In some wireless communications systems, a user equipment (UE) may search for control signaling from a network entity by monitoring control channel elements (CCEs) of a control resource set. In some cases, one CCE may include six resource element groups (REGs), where each REG corresponds to one resource block in one symbol. CCEs may be mapped to resource blocks in the control resource set with interleaving or non-interleaving. For non-interleaved mapping, all REGs of a CCE may be in continuous resource blocks, and the network entity may use a same precoder for each REG of the CCE. For interleaved mapping, the network entity may transmit REGs of a CCE in bundles, referred to as REG bundles, across different resource blocks of the control resource set. The network entity may configure a REG bundle size based on a quantity of symbols for the control resource set, and the network entity may use a same precoder within a REG bundle. The UE may receive a demodulation reference signal (DMRS) with the control signaling and perform channel estimation using the DMRS to decode the control signaling. In some cases, the channel estimation may be performed at the REG bundle level, such as for each REG bundle.

In some wireless communications systems, such as some Long Term Evolution (LTE) systems, a network entity may transmit a cell-specific reference signal (CRS), which may improve channel estimation performance at UEs. Some wireless communications systems, such as some New Radio (NR) systems, may not implement CRS. To improve channel estimation performance, some wireless communications systems may implement DMRS sharing, where a network entity transmits a common DMRS for multiple control channels (e.g., the control channels of multiple UEs), improving channel estimation quality for decoding of each of the control channels. As such, the network entity may configure common physical resource block (PRB) groups (PRGs) across the control resource set, and the network entity may use a same precoder within a given PRG. The network entity may transmit a shared DMRS for multiple control channels on a per PRG basis to allow the receiving UEs to perform PRG-based channel estimation. With DMRS sharing, channel estimation performance may be improved due to an increase in bandwidth associated with the shared DMRS due to the spreading of the REG bundles across different PRGs, however, this may come at a cost of increased overhead.

As described herein, a wireless communications system may implement techniques for embedding a shared DMRS within a physical downlink control channel (PDCCH) transmission and for allowing for deterministic or opportunistic DMRS sharing based on whether multiple PDCCHs share a same or an overlapping PDCCH candidate CCE. This may allow for improved inter-cell interference management.

Aspects of the disclosure are initially described in the context of wireless communications systems. Aspects of the disclosure are further illustrated by and described with reference to apparatus diagrams, system diagrams, and flowcharts that relate to interlaced sub-resource element group (sub-REG) bundles in nested search spaces for PDCCH DMRS sharing.

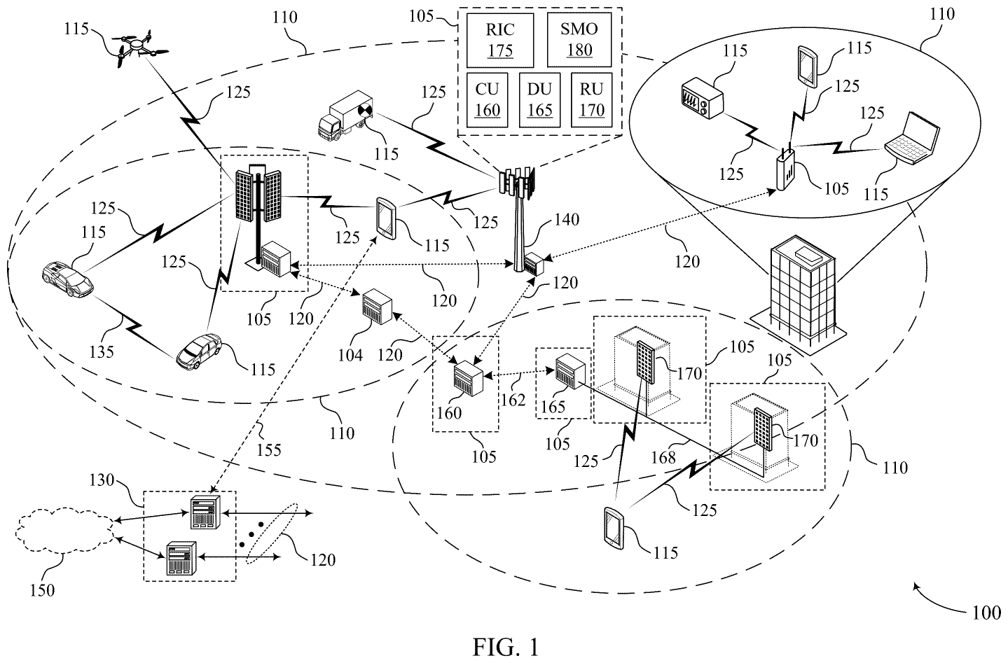

FIG. 1 shows an example of a wireless communications system 100 that supports interlaced sub-REG bundles in nested search spaces for PDCCH DMRS sharing in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support interlaced sub-REG bundles in nested search spaces for PDCCH DMRS sharing as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N^{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nr) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., CCEs) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, a UE 115 may search for control signaling from a network entity 105 by monitoring CCEs of a control resource set. In some cases, one CCE may include six REGs and each REG may correspond to one resource block in one symbol. The UE 115 may receive a DMRS with the control signaling and perform channel estimation using the DMRS to decode the control signaling.

The CCEs may be mapped to resource blocks in the control resource set with interleaving or non-interleaving. For non-interleaved mapping, all REGs of a CCE may be in continuous resource blocks, and the network entity may use a same precoder for each REG of the CCE. For interleaved mapping, the network entity 105 may transmit REGs of a CCE in REG bundles across different resource blocks of the control resource set. The network entity 105 may configure a REG bundle size based on a quantity of symbols for the control resource set, and the network entity 105 may use a same precoder within a REG bundle. A REG bundle size may include, for example, two, three, or six REGs based on the quantity of symbols for the control resource set.

In some wireless communications systems, such as an LTE system, a network entity may transmit a CRS, which may improve channel estimation performance at one or more UEs 115. Some wireless communications systems, such as some NR systems, may not implement CRS. To improve channel estimation performance, some wireless communications systems, such as the wireless communications system 100, may implement DMRS sharing, where a network entity 105 transmits a common DMRS for control channels of multiple UEs 115, improving channel estimation quality for decoding each of the control channels. The network entity 105 may configure common PRGs across the control resource set, and the network entity 105 may transmit a shared DMRS for multiple control channels on a per PRG basis to allow the receiving UEs to perform PRG-based channel estimation. With DMRS sharing, channel estimation performance may be improved due to an increase in bandwidth associated with the shared DMRS due to the spreading of the REG bundles across different PRGs, however, this may come at a cost of increased overhead.

In accordance with aspects described herein, the wireless communications system 100 may implement techniques for embedding a shared DMRS within a PDCCH transmission and for allowing for deterministic or opportunistic DMRS sharing based on whether multiple PDCCHs share a same or an overlapping PDCCH candidate CCE. In some implementations, the network entity 105 may configure a sub-REG bundle interlaced search space associated with an interlaced PDCCH candidate set. The sub-REG bundle interlaced search space may be based on a virtual partitioning of each of a plurality of REG bundles of an initial (e.g., a legacy) search space associated with an initial (e.g., a legacy) PDCCH candidate set, into a plurality of sub-REG bundles that are spread in a frequency domain across the initial REG bundles. Thus, for a control message transmitted via a PDCCH in the sub-REG bundle interlaced search space, a group of PDCCHs sharing the same candidate set may exploit the common DMRS with a wider bandwidth for improved channel estimation.

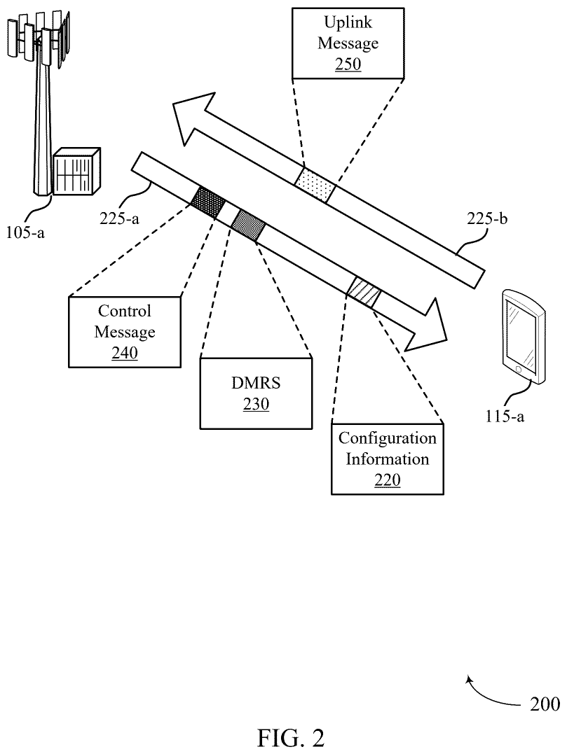

FIG. 2 shows an example of a portion of a wireless communications system 200 that supports interlaced sub-REG bundles in nested search spaces for PDCCH DMRS sharing in accordance with one or more aspects of the present disclosure. In some cases, the wireless communications system 200 may support or be supported by aspects of the wireless communications system 100 described with reference to FIG. 1. For instance, the wireless communications system 200 may include a network entity 105-a and a UE 115-a, which may be examples of network entities 105 and UEs 115, respectively, described with reference to FIG. 1. The network entity 105-a and UE 115-a may communicate using communication links 225 (e.g., a Uu link), which may be examples of the communication link(s) 125 described with reference to FIG. 1.

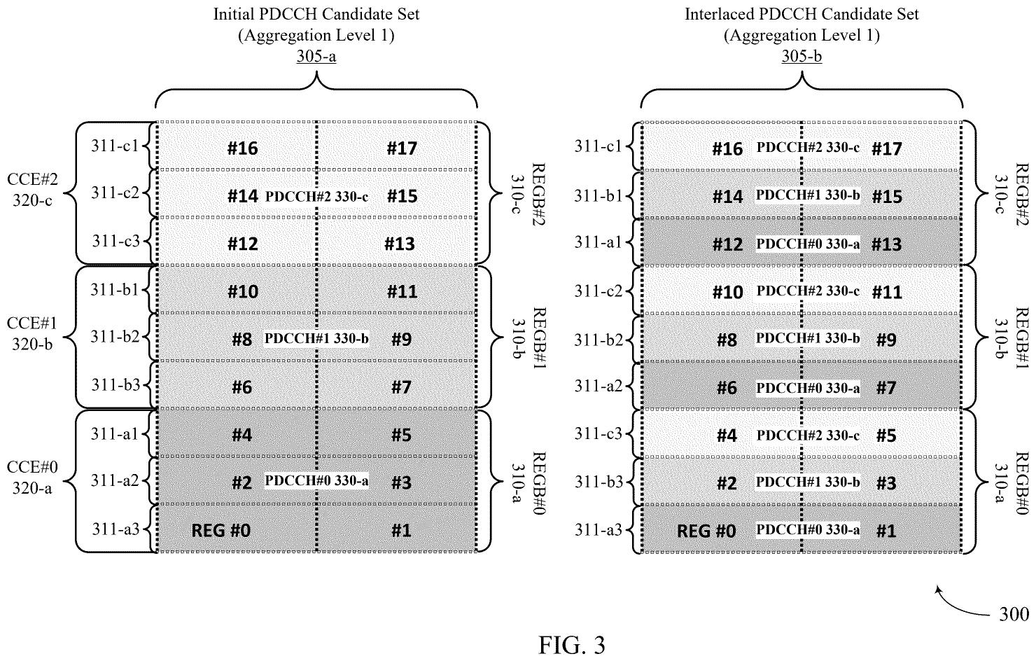

For instance, the network entity 105-a may transmit, and the UE 115-a may receive, downlink communications, such as a configuration information 220, via a downlink communication link 225-a. In accordance with aspects described herein, the configuration information 220 may include an indication of a sub-REG bundle interlaced search space associated with an interlaced PDCCH candidate set and an indication of DMRS sharing across a plurality of PDCCHs associated with the interlaced PDCCH candidate set, as discussed in further detail with reference to FIGS. 3 to 6. The plurality of PDCCHs may be associated with a plurality of different UEs, including the UE 115-a. The network entity 105-a may additionally transmit, and the UE 115-a may receive, a common DMRS 230, via the downlink communication link 225-a. The common DMRS 230 may be a DMRS that is shared across the plurality of PDCCHs associated with the interlaced PDCCH candidate set to assist in decoding the PDCCHs. The network entity 105-a may additionally transmit, and the UE 115-a may receive, a control message 240, via the downlink communication link 225. The control message 240 may be transmitted via a PDCCH, of the plurality of PDCCHs within the interlaced PDCCH candidate set, that is targeted to the UE 115-a. Additionally, the UE 115-a may transmit, and the network entity 105-a may receive, uplink communications, such as an uplink message 250, via an uplink communication link 225-b. In some cases, the uplink message 250 may be an indication of a channel estimate of a PDCCH based on the common DMRS 230.

FIG. 3 shows an example of a control channel configuration 300 that supports interlaced sub-REG bundles in nested search spaces for PDCCH DMRS sharing in accordance with one or more aspects of the present disclosure. In some aspects, control channel configuration 300 may be implemented by aspects of the wireless communications systems 100 and 200, as described with reference to FIGS. 1 and 2. For example, network entity 105-a, UE 115-a, or a combination thereof, may be configured to operate in accordance with the control channel configuration 300.

In some implementations, the network entity 105-a may send to a UE 115-a configuration information 220 that includes an indication of a sub-REG bundle interlaced search space associated with an interlaced PDCCH candidate set and an indication of DMRS sharing across a plurality of PDCCHs associated with the interlaced PDCCH candidate set. As such, the network entity 105-a may define (e.g., virtually or physically) a search space within a control resource set where the UE 115-a may locate a PDCCH targeted to the UE 115-a. The search space may include a range of CCEs where a PDCCH candidate set may be located. A CCE may be the basic resource unit for a PDCCH. In some wireless communications systems, each CCE may include six REGs and each REG may correspond to one resource block in one symbol. In some cases, the network entity 105-a may also define a quantity of REGs (e.g., 2, 3, 6, etc. REGs) as a REG bundle. The network entity 105-a may determine the REG bundle size based on the quantity of symbols in the control resource set. The network entity 105-a may, additionally, utilize an aggregation level to define a quantity of CCEs that form a given PDCCH. For example, in the case of aggregation level 1, one CCE (e.g., six REGs) may be used to form each PDCCH. Based on the aggregation level, the network entity 105-a may assign specific groups of CCEs, within the initial search space, as PDCCH candidates for specific UEs, and each of the UEs may monitor their respective PDCCH candidate sets for a PDCCH transmission targeted to the that UE 115.

In accordance with aspects described herein, the network entity 105-a may define an initial search space. In some cases, the initial search space may be a virtual search space used as a basis for configuring an interlaced search space. That is, the initial search space may be virtual for the sake of defining REG bundles and sub-REG bundles in a sub-REG bundle interlaced search space as described herein. In other cases, the initial search space may be a physical search space used by one or more UEs to search for one or more corresponding PDDCH control messages. The initial search space may include an aggregation level 1 initial PDCCH candidate set 305-a. In the example of FIG. 3, the initial PDCCH candidate set 305-a may include three CCEs 320 (although a PDCCH candidate set may not be limited to three CCEs), such as CCE #0 320-a, CCE #1 320-b, and CCE #2 320-c. The three CCEs 320 may each carry a respective PDCCH 330, such as PDCCH #0 330-a, PDCCH #1 330-b, and PDCCH #2 330-c. For example, the network entity 105-a may serve three UEs and the three PDCCHs 330 may be associated with the three UEs served by the network entity 105-a. Based on the quantity of symbols associated with the control resource set, the network entity 105-a may define REG bundles 310 as groups of six REGs, such as REGB #0 310-a, REGB #1 310-b, and REGB #2 310-c.

In some implementations, the network entity 105-a may utilize the initial search space to configure a sub-REG bundle interlaced search space. The sub-REG bundle interlaced search space may be based on a partitioning of the REG bundles 310 in the initial PDCCH candidate set 305-a, of the initial search space, into a plurality of sub-REG bundles 311 (e.g., partitioning REGB #0 310-a into sub-REG bundles 311-a1, 311-a2, and 311-a3, partitioning REGB #1 310-b into sub-REG bundles 311-b1, 311-b2, and 311-b3, and partitioning REGB #2 310-c into sub-REG bundles 311-c1, 311-c2, and 311-c3), and spreading those sub-REG bundles 311 across the initial (e.g., legacy) REG bundles 310 to create an interlaced PDCCH candidate set 305-b. For instance, the sub-REG bundles 311 may be spread across the initial REG bundles 310 in a frequency domain. Having smaller bundles of REGs (e.g., the sub-REG bundles 311) that are spread across large REG bundles may help to gain frequency diversity. Accordingly, the network entity 105-a may define a spreading factor K that indicates the quantity of sub-REG bundles 311 (e.g., 2, 3, 6, etc.) into which a given REG bundle 310 is to be partitioned (e.g., a spreading factor K where K is the quantity of sub-REG bundles per REG bundle), and consequently, the quantity of REG bundles 310 the sub-REG bundles 311 are to be spread across (e.g., an initial REG bundle is divided into K sub-REG bundles and spread across K REG bundles). For instance, assuming the REG bundles 310 have a size of N REGs, the sub-REG bundle 311 size may be defined as NIK. Accordingly, the resulting interlaced PDCCH candidate set 305-b may include the sub-REG bundles 311 spread across the K initial REB bundles 310. As a result of the spreading of the sub-REG bundles 311, the PDCCHs 330 may likewise be spread across the initial REG bundles 310. In some implementations, the network entity 105-a may maintain precoding at the REG bundle 310 level, which may allow a group of PDCCHs 330 within a same REG bundle 310 of the interlaced PDCCH candidate set 305-b to share a common DMRS. For instance, the group of PDCCHs 330 within the same REG bundle 310 may share a common DMRS sequence and the DRMS may be embedded within the PDCCHs 330. In some cases, the initial seed for DMRS scrambling may be determined based on a cell identifier (ID) or based on one or more common higher parameters. In this way, PDCCHs 330 within the interlaced PDCCH candidate set 305-b may be able to share a DMRS from other PDCCHs 330. For instance, a PDCCH 330 associated with the UE 115-a (e.g., targeted for the UE 115-a) may share a DMRS with a PDCCH 330 associated with one or more other UEs (e.g., targeted for one or more other UEs). For instance, a PDCCH 330 carried in the interlaced PDDCH candidate set 305-b may share a DMRS from the other PDCCHs carried in the other initial PDCCH candidate set 305-a or the PDCCH candidate set 305-b. For example, PDCCH #0 330-a in REGB #0 310-a may be targeted to UE 115-a and may share a DMRS with PDCCH #1 330-b and PDCCH #2 330-c in the same REGB #0 310.

In some implementations, the network entity 105-a may enable deterministic DMRS sharing. That is, when the interlaced PDCCH candidate set 305-b is configured, and the interlaced PDCCH candidate set 305-b carries a PDCCH 330 targeted for the UE 115-a, the PDCCHs 330 of each of the other UEs served by the network entity 105-a, and their corresponding DMRSs, may all be included in the same REG bundle 310 as the PDCCH 330 targeted for the UE 115-a. That is, in some cases, the network entity 105-a may not configure the interfaced PDCCH candidate set 305-b to carry the PDDCH 330 targeted for the UE 115-a in a REG bundle 310 by itself. In this way, the UE 115-a may be configured to assume that there is wideband DMRS (e.g., the DMRS shared across the REG bundle) in each REG bundle 310 that carries a PDCCH 330 targeted for the UE 115-a. In some cases, however, the network entity 105-a may not actually need to schedule resources for UEs other than the UE 115-a and, thus, PDCCHs for other UEs may not be needed. In such cases, the network entity 105-a may configure the interlaced PDCCH candidate set 305-b to include one or more empty PDCCH 330 in the REG bundle 310 along with the PDCCH 330 targeted for the UE 115-a. The network entity 105-a may configure the empty PDCCHs 330 with default padding DCI payload. In other cases, when the network entity 105-a has nothing to schedule for UEs other than the UE 115-a, the network entity 105-a may transmit the common DMRS, and might not configure the empty PDCCHs 330 for the interlaced PDCCH candidate set 305-b.

In some implementations, the network entity 105-a may enable opportunistic DMRS sharing. That is, when the interlaced PDCCH candidate set 305-b is configured, and the interlaced PDCCH candidate set 305-b carries a PDCCH 330 targeted for the UE 115-a, the network entity 105-a may determine that it is not advantageous for the REG bundle 310 carrying the PDCCH 330 targeted for the UE 115-a to also carry all of the PDCCHs 330 for the other UEs served by the network entity 105-a. In this case, the UE 115-a may be configured to attempt to detect the shared DMRSs associated with the other PDCCHs 330 in the same REG bundle 310 on a sub-REG bundle 311 basis. That is, the UE 115-a may attempt to detect the shared DMRSs associated with the other PDCCHs 330 in each sub-REG bundle 311 within the same REG bundle 310 as the PDCCH 330 targeted for the UE 115-a. If detected, the UE 115-a may then use the additional DMRSs in performing a channel estimation of the PDCCH 330 targeted for the UE 115-a.

The network entity 105-a may send, to a UE 115-a, control signaling (e.g., RRC signaling or other control signaling) including configuration information (e.g., configuration information 220 of FIG. 2) that indicates the initial PDCCH candidate set 305-a, the interlaced PDCCH candidate set 305-b, or both. In some cases, the configuration information may additionally include an indication that reference signal sharing (e.g., DMRS sharing) across a plurality of PDCCHs 330 associated with the interlaced PDCCH candidate set 305-b is implemented.

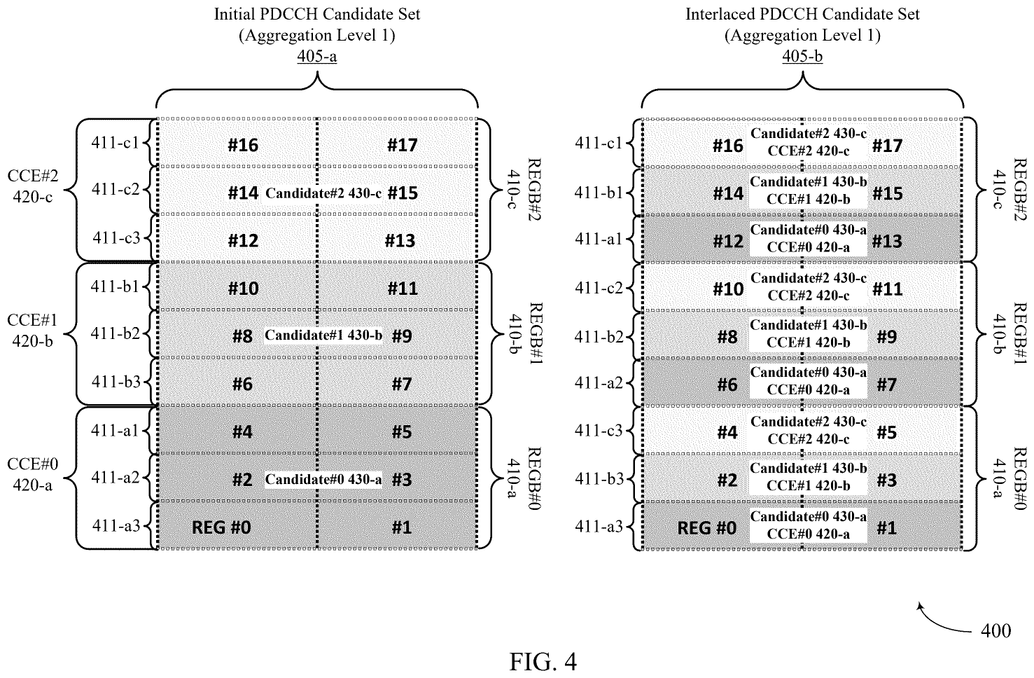

FIG. 4 shows an example of a control channel configuration 400 that supports interlaced sub-REG bundles in nested search spaces for PDCCH DMRS sharing in accordance with one or more aspects of the present disclosure. In some aspects, control channel configuration 400 may be implemented by aspects of the wireless communications systems 100 and 200, as described with reference to FIGS. 1 and 2, and the control channel configuration 300, as described with reference to FIG. 3. For example, network entity 105-a, UE 115-a, or a combination thereof, may be configured to operate in accordance with the control channel configuration 400.

In accordance with aspects described herein, the network entity 105-a may define (e.g., virtually or physically) an initial search space. In some cases, the initial search space may be used as a basis for configuring an interlaced search space. The initial search space may include an aggregation level 1 initial PDCCH candidate set 405-a. In the example of FIG. 4, the initial PDCCH candidate set 405-a may include three CCEs 420 (although a PDCCH candidate set may not be limited to three CCEs), such as CCE #0 420-a, CCE #1 420-b, and CCE #2 420-c. The three CCEs 420 may each carry a respective PDCCH candidate 430, such as Candidate #0 430-a, Candidate #1 430-b, and Candidate #2 430-c. Based on the quantity of symbols associated with the control resource set, the network entity 105-a may define REG bundles 410 as groups of six REGs, such as REGB #0 410-a, REGB #1 410-b, and REGB #2 410-c.

In some implementations, the network entity 105-a may utilize the initial space to configure a nested sub-REG bundle interlaced search. The sub-REG bundle interlaced search space may be based on a partitioning of the REG bundles 410 in the initial PDCCH candidate set 405-a, of the initial search space, into a plurality of sub-REG bundles 311 (e.g., partitioning REGB #0 410-a into sub-REG bundles 411-a1, 411-a2, and 411-a3, partitioning REGB #1 410-b into sub-REG bundles 411-b1, 411-b2, and 411-b3, and partitioning REGB #2 410-c into sub-REG bundles 411-c1, 411-c2, and 411-c3), and spreading those sub-REG bundles 411 across the corresponding CCEs 420 of the PDCCH candidates 430 to create an interlaced PDCCH candidate set 405-b. For instance, the sub-REG bundles 411 may be spread across the initial CCEs 420 of the PDCCH candidates 430 in a frequency domain. That is, K (e.g., the spreading factor) sub-REG bundles 411 may be spread out in K REG bundles 410 in K CCEs 420. For instance, one CCE 420 of a PDDCH candidate 430 in the interlaced PDCCH candidate set 405-b may be spread across the corresponding CCE in K initial PDCCH candidates 430. This may allow K sub-REG bundles 411 to be spread out in K REG bundles 410 in K CCE 420, and each REG bundle 410 may include sub-REG bundles 411 from K PDCCH candidates 430.

In some cases, it may be advantageous to configure the initial search space and align the initial PDCCH candidate set 405-a in the initial search space with the interlaced PDCCH candidate set 405-b in the sub-REG bundle search space. This alignment may assist the UE 115-a with improved blind decoding in the interlaced PDCCH candidate set 405-b. For instance, the UE 115-a may perform blind decoding to locate a PDDCH carrying a control message targeted to the UE 115-a. This may involve the UE 115-a checking the PDCCH candidates 430 (e.g., the PDCCH candidates 430 in the initial PDCCH candidate set 405-a or the interlaced PDCCH candidate set 405-b) one by one to determine whether the UE 115-a is able to successfully decode a PDCCH candidate 430 and locate the PDCCH. If the decoding is unsuccessful (e.g., the PDCCH not located), the UE 115-a may attempt to decode the next PDCCH candidate 430 in the PDCCH candidate set 405 (e.g., the initial PDCCH candidate set 405-a or the interlaced PDCCH candidate set 405-b) until one is successfully decoded (e.g., the PDCCH is located) or there are no more candidates to check in the PDCCH candidate set 405. By aligning the initial PDCCH candidate set 405-a in the initial search space with the interlaced PDCCH candidate set 405-b in the sub-REG bundle search space, the UE 115-a may be able to perform a channel estimation when blind decoding PDCCH candidates in the initial PDCCH candidate set 405-a and, thereafter, reusing that channel estimation when performing blind decoding of the PDCCH candidates in the interlaced PDCCH candidate set 405-b to improve the blind decoding process in the interlaced PDCCH candidate set 405-b.

In some cases, the interlaced PDCCH candidate set 405-b may include multiple PDCCH candidates 430 (e.g., PDCCH candidate #0 430-a, PDCCH candidate #1 430-b, and PDCCH candidate #2 430-c). Accordingly, in some cases, the network entity 105-a may provide the UE 115-a with a hash function that may allow the UE 115-a to know where the CCEs 420 corresponding to the each of the PDCCH candidates 430 are located. For example, the CCE indices i for the CCEs 420 corresponding to a given PDCCH candidate 430 k, at time t, may be determined by the hash function

$${l}_{k , i} = L [ ( {Y}_{p , t} + ⌊ \frac{kC}{LM} ⌋ ) mod ⌊ \frac{c}{L} ⌋ ] + i ,$$

where C may be the total quantity of CCEs 420 in the control resource set, L may be the aggregation level, M may be the quantity of PDCCH candidates 430 for the aggregation level. Y_{p,t} may be the time-varying hashing parameter associated with CORESET p. For common search space (CSS), Y_{p,t}. For UE-specific search space (USS), Y_{p,t}=(AₚY_{p,t-1}) mod (65537), where Y_{p,-1}=C_{RNTI}.

Accordingly, in the interlaced PDCCH candidate set 405-b of the sub-REG bundle search space, every K PDCCH candidates 430 may be mapped to a same set of the CCEs 420, but with different sub-REG bundle interlace indices. That is, M PDCCH candidates 430 may be divided into

$$⌈ \frac{M}{K} ⌉$$

groups of PDCCH candidates 430, where PDCCH candidate k belongs to the

$$⌊ \frac{k}{K} ⌋ - th$$

group of PDCCH candidates 430. In this case, the n-th group of PDCCH candidates 430 may occupy the initial (e.g., from the initial PDCCH candidate set 405-a) CCE indices

$${l}_{{k}^{′} , i} = L [ ( {Y}_{p , t} + ⌊ \frac{nC}{LM} ⌋ K + ⌊ \frac{{k}^{′} C}{LM} ⌋ ) mod ⌊ \frac{c}{L} ⌋ ] + i for 0 \leq {k}^{′} < K .$$

In this way, PDCCH candidates 430 in the same group may share the same sets of CCEs 420 and candidate k may select the k mod K-th interlace.

The network entity 105-a may send, to a UE 115-a, control signaling (e.g., RRC signaling or other control signaling) including configuration information (e.g., configuration information 220 of FIG. 2) that indicates the initial PDCCH candidate set 405-a, the interlaced PDCCH candidate set 405-b, or both. In some cases, the configuration information may additionally include an indication that reference signal sharing (e.g., DMRS sharing) across a plurality of PDCCHs associated with the interlaced PDCCH candidate set 405-b is implemented.

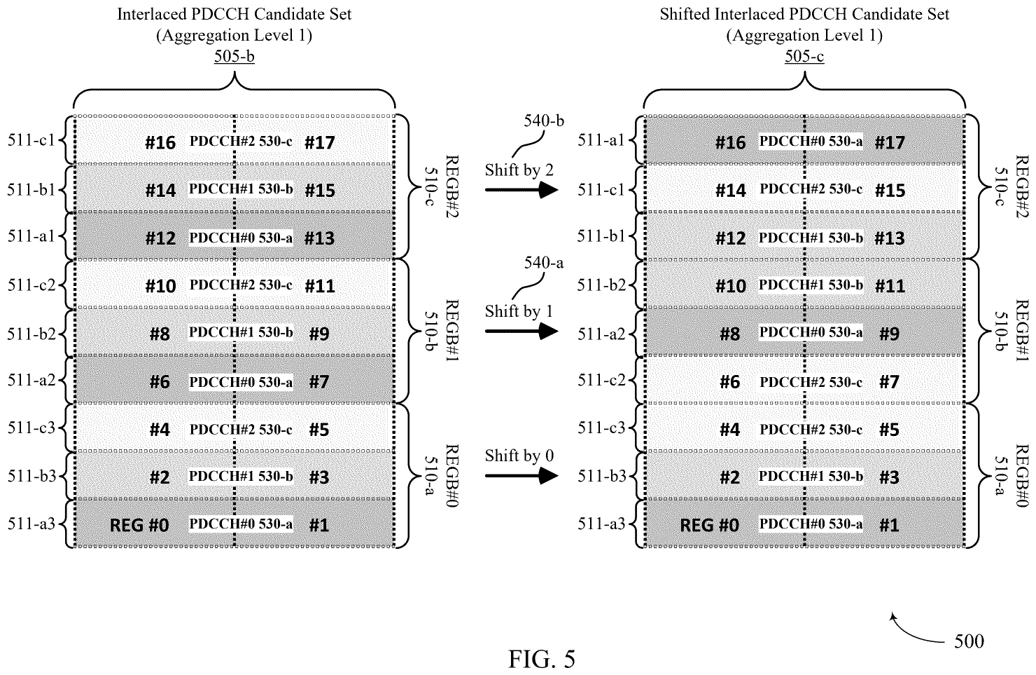

FIG. 5 shows an example of a control channel configuration 500 that supports interlaced sub-REG bundles in nested search spaces for PDCCH DMRS sharing in accordance with one or more aspects of the present disclosure. In some aspects, control channel configuration 500 may be implemented by aspects of the wireless communications systems 100 and 200, as described with reference to FIGS. 1 and 2, and the control channel configurations 300 and 400, as described with reference to FIGS. 3 and 4. For example, network entity 105-a, UE 115-a, or a combination thereof, may be configured to operate in accordance with the control channel configuration 500.

In some implementations, the network entity 105-a may define (e.g., virtually or physically) an initial search space and utilize the initial search space to configure a sub-REG bundle interlaced search space to includes an interlaced PDCCH candidate set, such the interlaced PDCCH candidate set 305-b of FIG. 3 or the interlaced PDCCH candidate set 405-b of FIG. 4. For instance, the network may configure an interlaced PDCCH candidate set 505-b, which may be similar to the interlaced PDCCH candidate set 305-b of FIG. 3. For instance, the interlaced PDCCH candidate set 505-b may include a plurality of sub-REG bundles 511 (sub-REG bundles 511-a1, 511-a2, 511-a3, 511-b1, 511-b2, 511-b3, 511-c1, 511-c2, and 511-c3) that are spread in a frequency domain across a plurality of REG bundles 510 (e.g., REGB #0 510-a, REGB #1 510-b, and REGB #2 510-c).

In some implementations, the network entity 105-a may perform a cyclic shift within one or more of the REG bundles 510 of the interlaced PDCCH candidate set 505-b to generate a shifted interlaced PDCCH candidate set 505-c. For instance, in some cases when DMRS sharing is utilized, if multiple PDCCHs are transmitted within a given REG bundle 510, channel estimation may be performed on the REG bundle 510. However, in some cases, channel estimation performance may be worse at the edge tones of the REG bundle 510. That is, after interlacing, the edge resource blocks of the REG bundle 510 may have a decreased channel estimation quality.

Accordingly, to avoid sub-REG bundles 511 sitting on edge resource blocks of the REG bundle 510, after interlacing the sub-REG bundles 511, the network entity 105-a may apply different sub-REG bundle resource block cyclic shifts in different REG bundles 510 to generate the shifted interlaced PDCCH candidate set 505-c. For example, the network entity 105-a may apply a pseudo random shift to sub-REG bundles 511 within a REG bundle 510, such that a sub-REG bundle 511 may not consistently sit on an edge resource block of a REG bundle 510. In some examples, the network entity 105-a may add a pseudo random shift under modulation operation per REG bundle 510.

For example, as shown in the interlaced PDCCH candidate set 505-b, PDCCHs 530 (e.g., PDCCH #0 530-a, PDCCH #1 530-b, and PDCCH #2 530-c) may be spread across the various sub-REG bundles 511. In this example, PDCCH #0 530-a (carried in sub-REG bundles 511-a1, 511-a2, and 511-a3) and PDCCH #2 530-c (carried in sub-REG bundles 511-c1, 511-c2, and 511-c3) may sit on edge resource blocks of the corresponding REG bundles 510.

However, as shown in the shifted interlaced PDCCH candidate set 505-c, after applying the cyclic shift 540-a, that shifts the sub-REG bundles within REGB #1 510-b by 1, the PDCCH #0 530-a (carried in sub-REG bundle 511-a2) may no longer sit on the edge of REG bundle 510-b. Likewise, after applying the cyclic shift 540-b, that shifts the sub-REG bundles within REGB #2 510-c by 2, the PDCCH #2 530-c (carried in sub-REG bundle 511-c1) may no longer sit on the edge of REG bundle 510-c.

The network entity 105-a may send, to the UE 115-a, control signaling (e.g., RRC signaling or other control signaling) including configuration information (e.g., configuration information 220 of FIG. 2) that indicates the interlaced PDCCH candidate set 505-b, the shifted interlaced PDCCH candidate set 505-c, a pseudo random shift offset value, or combination thereof. In some cases, the configuration information may additionally include an indication that reference signal sharing (e.g., DMRS sharing) across a plurality of PDCCHs 530 associated with the interlaced PDCCH candidate set 505-b, the shifted interlaced PDCCH candidate set 505-c, or both is implemented.

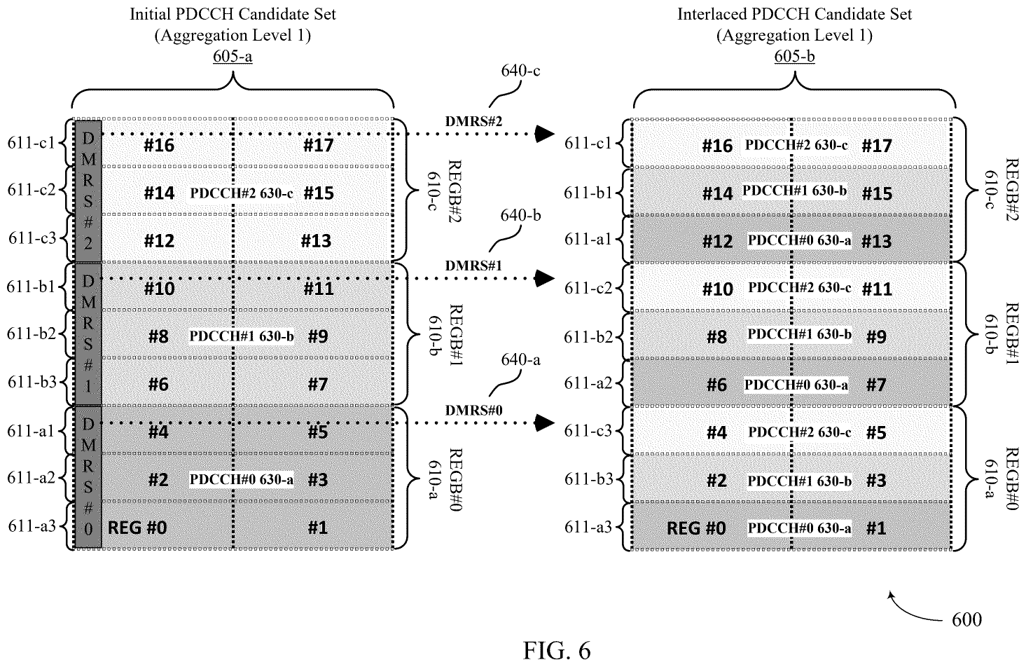

FIG. 6 shows an example of a control channel configuration 600 that supports interlaced sub-REG bundles in nested search spaces for PDCCH DMRS sharing in accordance with one or more aspects of the present disclosure. In some aspects, control channel configuration 600 may be implemented by aspects of the wireless communications systems 100 200, as described with reference to FIGS. 1 and 2, and the control channel configurations 300, 400, and 500, as described with reference to FIGS. 3, 4, and 5. For example, network entity 105-a, UE 115-a, or a combination thereof, may be configured to operate in accordance with the control channel configuration 500.

In some implementations, when the network entity 105-a configures both the initial search space and the interlaced sub-REG bundle search space, and the two search spaces are overlapping in both a frequency and a time domain, the network entity 105-a may enable the UE 115-a to perform channel estimation sharing. That is, the network entity 105-a may enable the UE 115-a to exploit a channel estimation performed on the initial search space when blind decoding the interlaced sub-REB bundle search space.

Accordingly, the network entity 105-a may configure the UE 115-a to monitor both the initial search space and the interlaced sub-REG bundle search space when the two are overlapping. In this case, the UE 115-a may initially blind decode the initial PDCCH candidate set 605-a of the initial search space. In some cases, during the blind decoding, the UE 115-a may opportunistically detect a DMRS 640 (e.g., a DMRS #0 640-a associated with PDCCH #0 630-a, DMRS #1 640-b associated with PDCCH #1 630-b, and DMRS #2 640-c associated with PDCCH #2 630-c). The UE 115-a may perform a channel estimation using the detected DMRS 640 and may store the channel estimate associated with the initial PDCCH candidate set 605-a. Subsequently, the UE 115-a may decode the interlaced PDCCH candidate set 605-b of the interlaced sub-REB bundle search space and may reuse the stored channel estimate associated with the initial PDCCH candidate set 605-a for decoding PDCCH candidates in the interlaced PDCCH candidate set 605-b. That is, the network entity 105-a may transmit a shared DMRS across a given REG bundle, the DMRS sequence and the resources occupied by the shared DMRS may be the same for the initial PDCCH candidate set 605-a and the interlaced PDCCH candidate set 605-b, thus, the channel estimation based on the initial PDCCH candidate set 605-a may also apply to the interlaced PDCCH candidate set 605-b that overlaps with the initial PDCCH candidate set 605-a. Using the channel estimate from the initial PDCCH candidate set 605-a may be advantageous because the DMRS associated with initial PDCCH candidate set 605-a may have a wider bandwidth since the REG bundles 610 in the initial PDCCH candidate set 605-a are larger than those in the sub-REG bundles 611 in the interlaced PDCCH candidate set 605-b.

The network entity 105-a may send, to the UE 115-a, control signaling (e.g., RRC signaling or other control signaling) including configuration information (e.g., configuration information 220 of FIG. 2) that indicates the initial PDCCH candidate set 605-a, the interlaced PDCCH candidate set 505-b, or both. In some cases, the configuration information may additionally include an indication that reference signal sharing (e.g., DMRS sharing) across a plurality of PDCCHs 630 associated with the interlaced PDCCH candidate set 605-b is implemented.

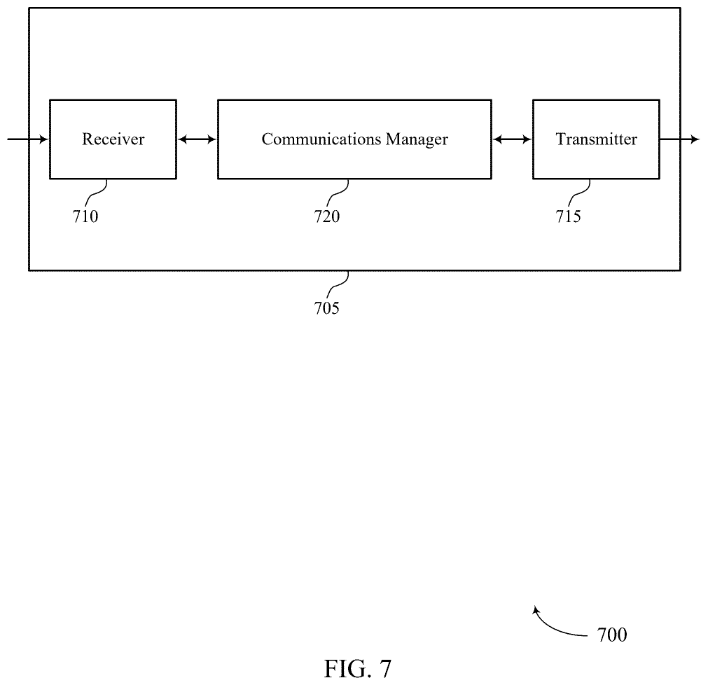

FIG. 7 shows a block diagram 700 of a device 705 that supports interlaced sub-REG bundles in nested search spaces for PDCCH DMRS sharing in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to interlaced sub-REG bundles in nested search spaces for PDCCH DMRS sharing). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to interlaced sub-REG bundles in nested search spaces for PDCCH DMRS sharing). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of interlaced sub-REG bundles in nested search spaces for PDCCH DMRS sharing as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving control channel configuration information indicating: a sub-resource element group sub-REG bundle interlaced search space associated with an interlaced PDCCH candidate set, and reference signal sharing across a set of multiple PDCCHs associated with the interlaced PDCCH candidate set. The communications manager 720 is capable of, configured to, or operable to support a means for monitoring, based on the control channel configuration information, the interlaced PDCCH candidate set for a target PDCCH, of the set of multiple PDCCHs, that is associated with the UE. The communications manager 720 is capable of, configured to, or operable to support a means for receiving, via the sub-REG bundle interlaced search space and the target PDCCH, a control message.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

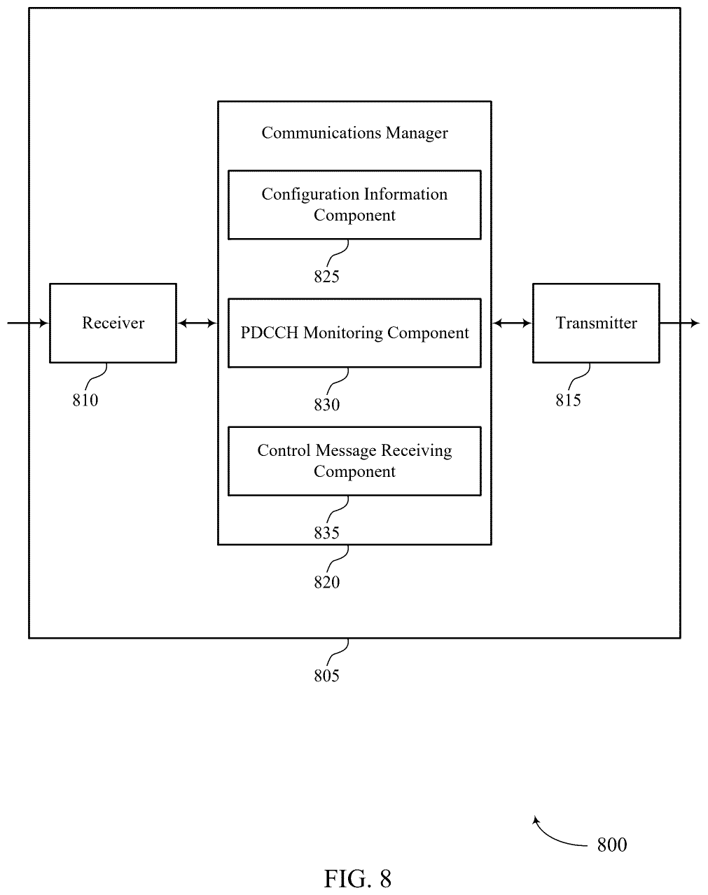

FIG. 8 shows a block diagram 800 of a device 805 that supports interlaced sub-REG bundles in nested search spaces for PDCCH DMRS sharing in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to interlaced sub-REG bundles in nested search spaces for PDCCH DMRS sharing). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to interlaced sub-REG bundles in nested search spaces for PDCCH DMRS sharing). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of interlaced sub-REG bundles in nested search spaces for PDCCH DMRS sharing as described herein. For example, the communications manager 820 may include a configuration information component 825, a PDCCH monitoring component 830, a control message receiving component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The configuration information component 825 is capable of, configured to, or operable to support a means for receiving control channel configuration information indicating: a sub-REG bundle interlaced search space associated with an interlaced PDCCH candidate set, and reference signal sharing across a set of multiple PDCCHs associated with the interlaced PDCCH candidate set. The PDCCH monitoring component 830 is capable of, configured to, or operable to support a means for monitoring, based on the control channel configuration information, the interlaced PDCCH candidate set for a target PDCCH, of the set of multiple PDCCHs, that is associated with the UE. The control message receiving component 835 is capable of, configured to, or operable to support a means for receiving, via the sub-REG bundle interlaced search space and the target PDCCH, a control message.

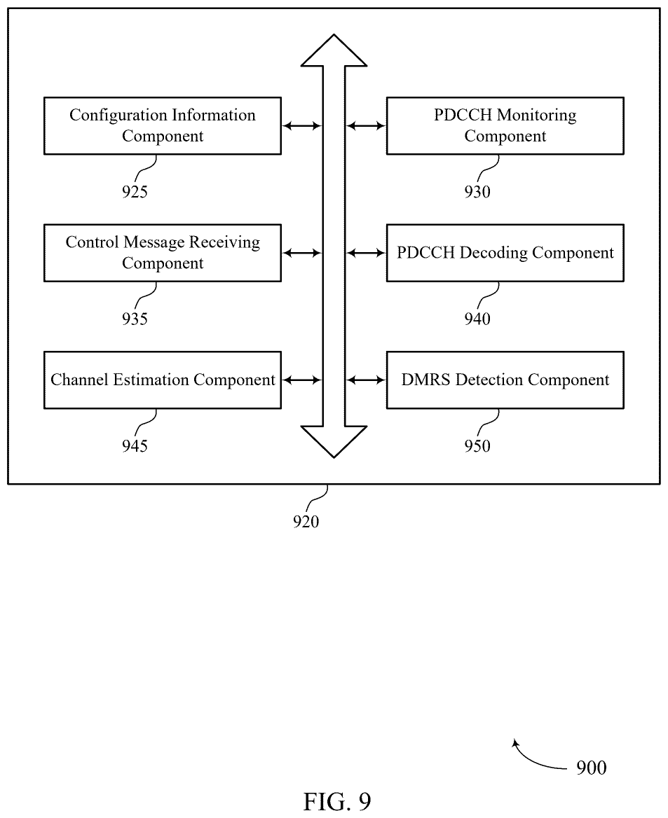

FIG. 9 shows a block diagram 900 of a communications manager 920 that supports interlaced sub-REG bundles in nested search spaces for PDCCH DMRS sharing in accordance with one or more aspects of the present disclosure. The communications manager 920 may be an example of aspects of a communications manager 720, a communications manager 820, or both, as described herein. The communications manager 920, or various components thereof, may be an example of means for performing various aspects of interlaced sub-REG bundles in nested search spaces for PDCCH DMRS sharing as described herein. For example, the communications manager 920 may include a configuration information component 925, a PDCCH monitoring component 930, a control message receiving component 935, a PDCCH decoding component 940, a channel estimation component 945, a DMRS detection component 950, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The configuration information component 925 is capable of, configured to, or operable to support a means for receiving control channel configuration information indicating: a sub-REG bundle interlaced search space associated with an interlaced PDCCH candidate set, and reference signal sharing across a set of multiple PDCCHs associated with the interlaced PDCCH candidate set. The PDCCH monitoring component 930 is capable of, configured to, or operable to support a means for monitoring, based on the control channel configuration information, the interlaced PDCCH candidate set for a target PDCCH, of the set of multiple PDCCHs, that is associated with the UE. The control message receiving component 935 is capable of, configured to, or operable to support a means for receiving, via the sub-REG bundle interlaced search space and the target PDCCH, a control message.

In some examples, the sub-REG bundle interlaced search space is based on a partition of each initial REG bundle, of a set of multiple initial REG bundles of an initial search space associated with an initial PDCCH candidate set, into a set of multiple respective sub-REG bundles that are spread in a frequency domain across the set of multiple initial REG bundles.

In some examples, the initial search space includes a virtual search space.

In some examples, the control channel configuration information further indicates a spreading factor indicating a quantity of sub-REG bundles into which each initial REG bundle is partitioned.

In some examples, a first subset of PDCCHs of the set of multiple PDCCHs share a common DMRS sequence associated with a shared DMRS. In some examples, the first subset of PDCCHs are associated with a first initial REG bundle of the set of multiple initial REG bundles. In some examples, the shared DMRS is embedded within one or more PDCCHs of the first subset of PDCCHs.

In some examples, to support monitoring the interlaced PDCCH candidate set for the target PDCCH, the PDCCH decoding component 940 is capable of, configured to, or operable to support a means for performing, based on the initial search space and the sub-REG bundle interlaced search space at least partially overlapping, blind decoding of the initial PDCCH candidate set for the target PDCCH. In some examples, to support monitoring the interlaced PDCCH candidate set for the target PDCCH, the channel estimation component 945 is capable of, configured to, or operable to support a means for performing, based on detection of a shared DMRS during the blind decoding of the initial PDCCH candidate set, channel estimation, where the shared DMRS is embedded in the target PDCCH. In some examples, to support monitoring the interlaced PDCCH candidate set for the target PDCCH, the PDCCH decoding component 940 is capable of, configured to, or operable to support a means for performing, based on the channel estimation, blind decoding of the interlaced PDCCH candidate set for the target PDCCH.

In some examples, the sub-REG bundle interlaced search space is based on a partition of each initial REG bundle, of a set of multiple initial REG bundles associated with respective CCEs of an initial PDCCH candidate of a set of multiple PDCCH candidates of an initial search space associated with an initial PDCCH candidate set, into a set of multiple respective sub-REG bundles that are spread in a frequency domain across the set of multiple initial REG bundles.

In some examples, the sub-REG bundle interlaced search space is based on a partition of each initial REG bundle, of a set of multiple initial REG bundles, into a set of multiple respective sub-REG bundles. In some examples, an RB cyclic shift is associated with one or more sub-REG bundles of the set of multiple respective sub-REG bundles. In some examples, different initial REG bundles are associated with different RB cyclic shifts.

In some examples, one or more other PDCCHs, of the set of multiple PDCCHs, are included in a same REG bundle as the target PDCCH in the sub-REG bundle interlaced search space.

In some examples, the DMRS detection component 950 is capable of, configured to, or operable to support a means for detecting, based at least on one or more sub-REG bundles of the same REG bundle monitored as the target PDCCH, a shared DMRS transmitted by at least one of the one or more other PDCCHs. In some examples, the channel estimation component 945 is capable of, configured to, or operable to support a means for performing, based on detection of the shared DMRS, channel estimation.

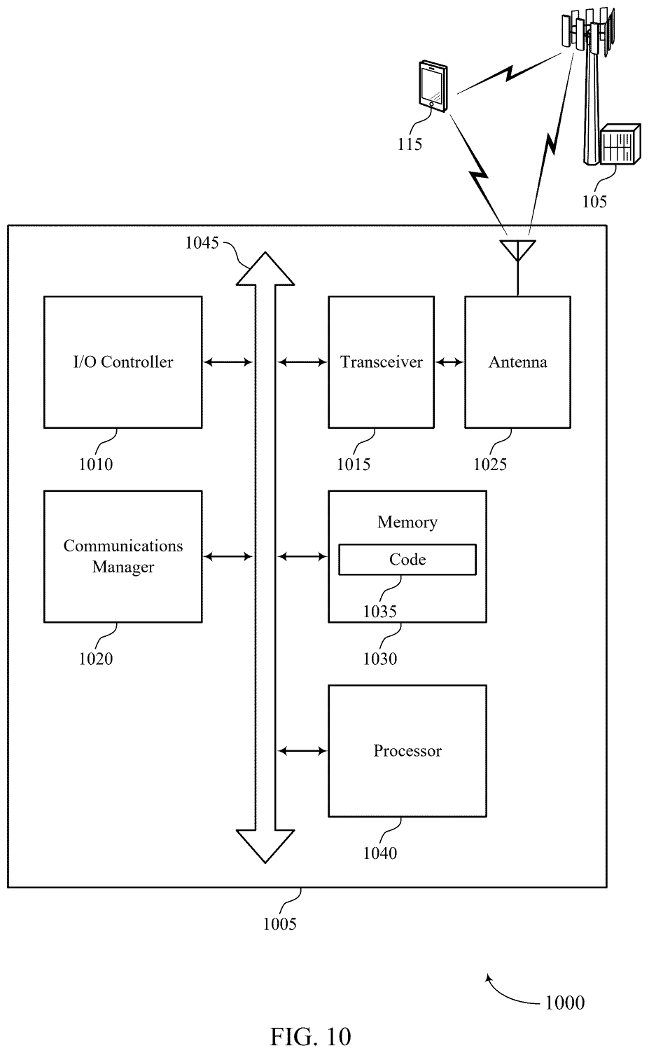

FIG. 10 shows a diagram of a system 1000 including a device 1005 that supports interlaced sub-REG bundles in nested search spaces for PDCCH DMRS sharing in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting interlaced sub-REG bundles in nested search spaces for PDCCH DMRS sharing). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving control channel configuration information indicating: a sub-REG bundle interlaced search space associated with an interlaced PDCCH candidate set, and reference signal sharing across a set of multiple PDCCHs associated with the interlaced PDCCH candidate set. The communications manager 1020 is capable of, configured to, or operable to support a means for monitoring, based on the control channel configuration information, the interlaced PDCCH candidate set for a target PDCCH, of the set of multiple PDCCHs, that is associated with the UE. The communications manager 1020 is capable of, configured to, or operable to support a means for receiving, via the sub-REG bundle interlaced search space and the target PDCCH, a control message.

By including or configuring the communications manager 1020 in accordance with examples as described herein, the device 1005 may support techniques for more efficient utilization of communication resources and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of interlaced sub-REG bundles in nested search spaces for PDCCH DMRS sharing as described herein, or the at least one processor 1040 and the at least one memory 1030 may be otherwise configured to, individually or collectively, perform or support such operations.

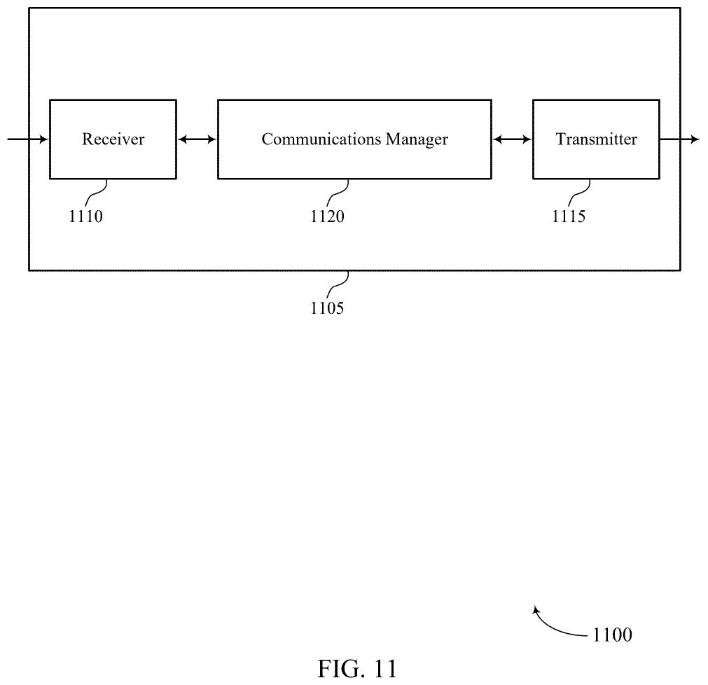

FIG. 11 shows a block diagram 1100 of a device 1105 that supports interlaced sub-REG bundles in nested search spaces for PDCCH DMRS sharing in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of interlaced sub-REG bundles in nested search spaces for PDCCH DMRS sharing as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for transmitting control channel configuration information indicating a sub-REG bundle interlaced search space associated with an interlaced PDCCH candidate set and indicating reference signal sharing across a set of multiple PDCCHs associated with the interlaced PDCCH candidate set, where the set of multiple PDCCHs are associated with a set of multiple UEs. The communications manager 1120 is capable of, configured to, or operable to support a means for transmitting, based on the control channel configuration information, one or more control messages via the set of multiple PDCCHs within the interlaced PDCCH candidate set.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficient utilization of communication resources.

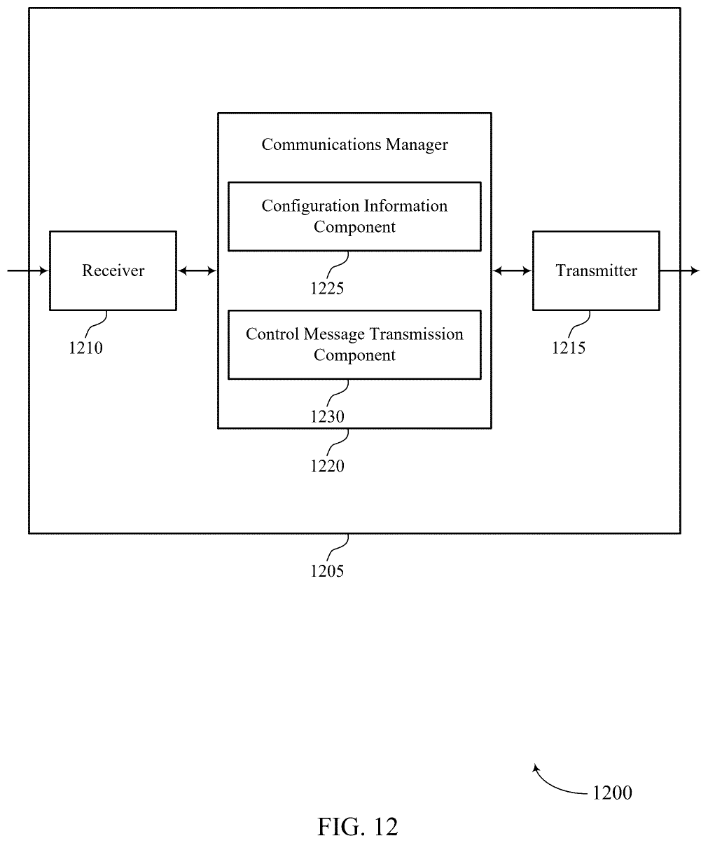

FIG. 12 shows a block diagram 1200 of a device 1205 that supports interlaced sub-REG bundles in nested search spaces for PDCCH DMRS sharing in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of interlaced sub-REG bundles in nested search spaces for PDCCH DMRS sharing as described herein. For example, the communications manager 1220 may include a configuration information component 1225 a control message transmission component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The configuration information component 1225 is capable of, configured to, or operable to support a means for transmitting control channel configuration information indicating a sub-REG bundle interlaced search space associated with an interlaced PDCCH candidate set and indicating reference signal sharing across a set of multiple PDCCHs associated with the interlaced PDCCH candidate set, where the set of multiple PDCCHs are associated with a set of multiple UEs. The control message transmission component 1230 is capable of, configured to, or operable to support a means for transmitting, based on the control channel configuration information, one or more control messages via the set of multiple PDCCHs within the interlaced PDCCH candidate set.

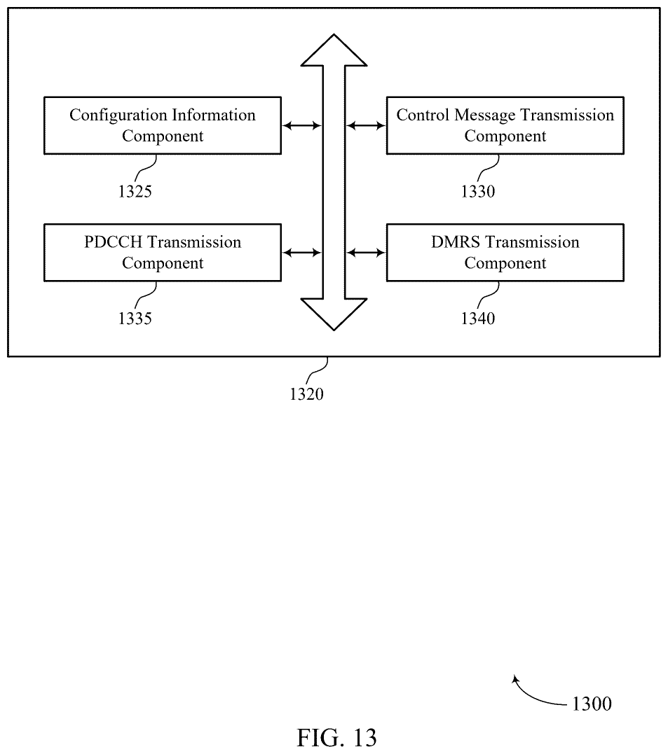

FIG. 13 shows a block diagram 1300 of a communications manager 1320 that supports interlaced sub-REG bundles in nested search spaces for PDCCH DMRS sharing in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of interlaced sub-REG bundles in nested search spaces for PDCCH DMRS sharing as described herein. For example, the communications manager 1320 may include a configuration information component 1325, a control message transmission component 1330, a PDCCH transmission component 1335, a DMRS transmission component 1340, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The configuration information component 1325 is capable of, configured to, or operable to support a means for transmitting control channel configuration information indicating a sub-REG bundle interlaced search space associated with an interlaced PDCCH candidate set and indicating reference signal sharing across a set of multiple PDCCHs associated with the interlaced PDCCH candidate set, where the set of multiple PDCCHs are associated with a set of multiple UEs. The control message transmission component 1330 is capable of, configured to, or operable to support a means for transmitting, based on the control channel configuration information, one or more control messages via the set of multiple PDCCHs within the interlaced PDCCH candidate set.

In some examples, an initial search space is associated with an initial PDCCH candidate set and includes a set of multiple initial REG bundles. In some examples, the sub-REG bundle interlaced search space is based on a partition of each initial REG bundle, of the set of multiple initial REG bundles, into a set of multiple respective sub-REG bundles that are spread in a frequency domain across the set of multiple initial REG bundles.

In some examples, the initial search space includes a virtual search space.

In some examples, the control channel configuration information further indicates a spreading factor indicating a quantity of sub-REG bundles into which each initial REG bundle is partitioned.

In some examples, the DMRS transmission component 1340 is capable of, configured to, or operable to support a means for transmitting a shared DMRS associated with one or more PDCCHs of a first subset of PDCCHs of the set of multiple PDCCHs, where the first subset of PDCCHs are associated with a first initial REG bundle of the set of multiple initial REG bundles and share a common DMRS sequence associated with the shared DMRS.

In some examples, the control channel configuration information further indicates the initial search space. In some examples, the initial search space and the sub-REG bundle interlaced search space at least partially overlap.

In some examples, an initial search space is associated with an initial PDCCH candidate set and includes a set of multiple initial REG bundles associated with respective CCEs of an initial PDCCH candidate of a set of multiple PDCCH candidates. In some examples, the sub-REG bundle interlaced search space is based on a partition of each initial REG bundle, of the set of multiple initial REG bundles, into a set of multiple respective sub-REG bundles that are spread in a frequency domain across the set of multiple initial REG bundles.

In some examples, an initial search space is associated with an initial PDCCH candidate set and includes a set of multiple initial REG bundles. In some examples, the sub-REG bundle interlaced search space is based on a partition of each initial REG bundle, of the set of multiple initial REG bundles, into a set of multiple respective sub-REG bundles. In some examples, an RB cyclic shift is associated with one or more sub-REG bundles of the set of multiple respective sub-REG bundles. In some examples, different initial REG bundles are associated with different RB cyclic shifts.

In some examples, each of the set of multiple PDCCHs is included in one or more sub-REG bundles of a same REG bundle in the sub-REG bundle interlaced search space.

In some examples, each of the set of multiple PDCCHs is included in different REG bundles in the sub-REG bundle interlaced search space.

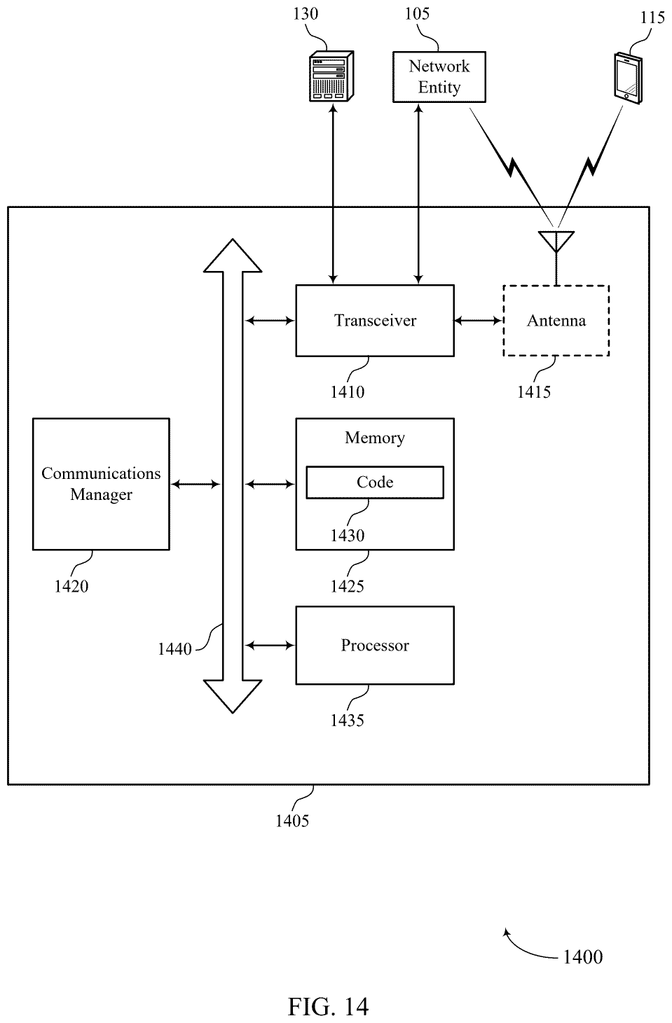

FIG. 14 shows a diagram of a system 1400 including a device 1405 that supports interlaced sub-REG bundles in nested search spaces for PDCCH DMRS sharing in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting interlaced sub-REG bundles in nested search spaces for PDCCH DMRS sharing). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for transmitting control channel configuration information indicating a sub-REG bundle interlaced search space associated with an interlaced PDCCH candidate set and indicating reference signal sharing across a set of multiple PDCCHs associated with the interlaced PDCCH candidate set, where the set of multiple PDCCHs are associated with a set of multiple UEs. The communications manager 1420 is capable of, configured to, or operable to support a means for transmitting, based on the control channel configuration information, one or more control messages via the set of multiple PDCCHs within the interlaced PDCCH candidate set.

By including or configuring the communications manager 1420 in accordance with examples as described herein, the device 1405 may support techniques for more efficient utilization of communication resources and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of interlaced sub-REG bundles in nested search spaces for PDCCH DMRS sharing as described herein, or the at least one processor 1435 and the at least one memory 1425 may be otherwise configured to, individually or collectively, perform or support such operations.

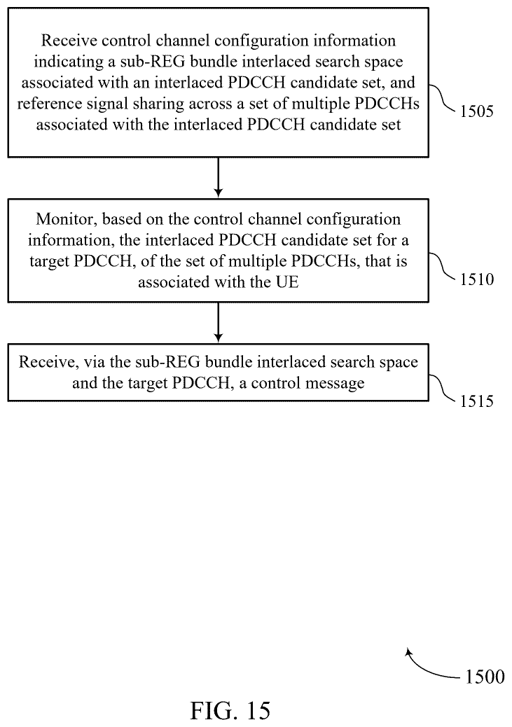

FIG. 15 shows a flowchart illustrating a method 1500 that supports interlaced sub-REG bundles in nested search spaces for PDCCH DMRS sharing in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving control channel configuration information indicating: a sub-REG bundle interlaced search space associated with an interlaced PDCCH candidate set, and reference signal sharing across a set of multiple PDCCHs associated with the interlaced PDCCH candidate set. The operations of 1505 may be performed in accordance with examples as disclosed herein. In some examples, aspects of the operations of 1505 may be performed by a configuration information component 925 as described with reference to FIG. 9.

At 1510, the method may include monitoring, based on the control channel configuration information, the interlaced PDCCH candidate set for a target PDCCH, of the set of multiple PDCCHs, that is associated with the UE. The operations of 1510 may be performed in accordance with examples as disclosed herein. In some examples, aspects of the operations of 1510 may be performed by a PDCCH monitoring component 930 as described with reference to FIG. 9.

At 1515, the method may include receiving, via the sub-REG bundle interlaced search space and the target PDCCH, a control message. The operations of 1515 may be performed in accordance with examples as disclosed herein. In some examples, aspects of the operations of 1515 may be performed by a control message receiving component 935 as described with reference to FIG. 9.

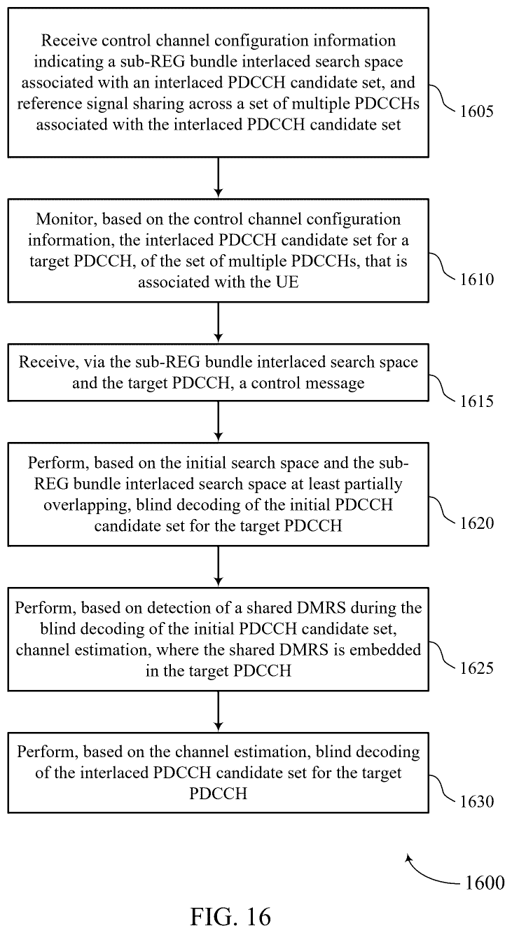

FIG. 16 shows a flowchart illustrating a method 1600 that supports interlaced sub-REG bundles in nested search spaces for PDCCH DMRS sharing in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving control channel configuration information indicating: a sub-REG bundle interlaced search space associated with an interlaced PDCCH candidate set, and reference signal sharing across a set of multiple PDCCHs associated with the interlaced PDCCH candidate set. The operations of 1605 may be performed in accordance with examples as disclosed herein. In some examples, aspects of the operations of 1605 may be performed by a configuration information component 925 as described with reference to FIG. 9.

At 1610, the method may include monitoring, based on the control channel configuration information, the interlaced PDCCH candidate set for a target PDCCH, of the set of multiple PDCCHs, that is associated with the UE. The operations of 1610 may be performed in accordance with examples as disclosed herein. In some examples, aspects of the operations of 1610 may be performed by a PDCCH monitoring component 930 as described with reference to FIG. 9.

At 1615, the method may include receiving, via the sub-REG bundle interlaced search space and the target PDCCH, a control message. The operations of 1615 may be performed in accordance with examples as disclosed herein. In some examples, aspects of the operations of 1615 may be performed by a control message receiving component 935 as described with reference to FIG. 9.

At 1620, the method may include performing, based on the initial search space and the sub-REG bundle interlaced search space at least partially overlapping, blind decoding of the initial PDCCH candidate set for the target PDCCH. The operations of 1620 may be performed in accordance with examples as disclosed herein. In some examples, aspects of the operations of 1620 may be performed by a PDCCH decoding component 940 as described with reference to FIG. 9.

At 1625, the method may include performing, based on detection of a shared DMRS during the blind decoding of the initial PDCCH candidate set, channel estimation, where the shared DMRS is embedded in the target PDCCH. The operations of 1625 may be performed in accordance with examples as disclosed herein. In some examples, aspects of the operations of 1625 may be performed by a channel estimation component 945 as described with reference to FIG. 9.

At 1630, the method may include performing, based on the channel estimation, blind decoding of the interlaced PDCCH candidate set for the target PDCCH. The operations of 1630 may be performed in accordance with examples as disclosed herein. In some examples, aspects of the operations of 1630 may be performed by a PDCCH decoding component 940 as described with reference to FIG. 9.

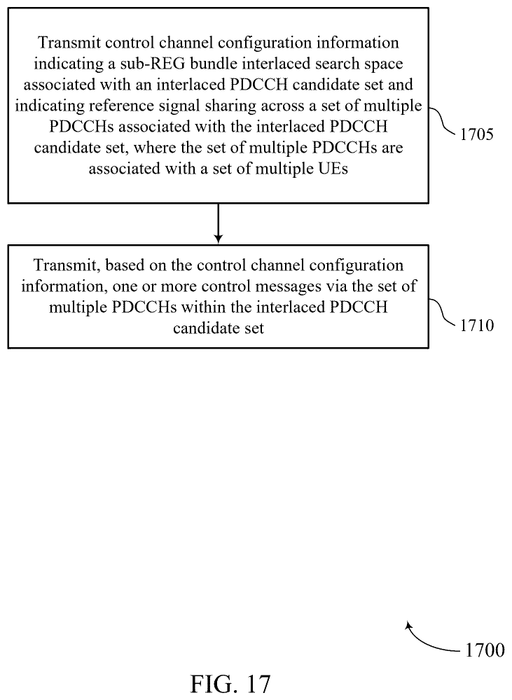

FIG. 17 shows a flowchart illustrating a method 1700 that supports interlaced sub-REG bundles in nested search spaces for PDCCH DMRS sharing in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include transmitting control channel configuration information indicating a sub-REG bundle interlaced search space associated with an interlaced PDCCH candidate set and indicating reference signal sharing across a set of multiple PDCCHs associated with the interlaced PDCCH candidate set, where the set of multiple PDCCHs are associated with a set of multiple UEs. The operations of 1705 may be performed in accordance with examples as disclosed herein. In some examples, aspects of the operations of 1705 may be performed by a configuration information component 1325 as described with reference to FIG. 13.

At 1710, the method may include transmitting, based on the control channel configuration information, one or more control messages via the set of multiple PDCCHs within the interlaced PDCCH candidate set. The operations of 1710 may be performed in accordance with examples as disclosed herein. In some examples, aspects of the operations of 1710 may be performed by a control message transmission component 1330 as described with reference to FIG. 13.

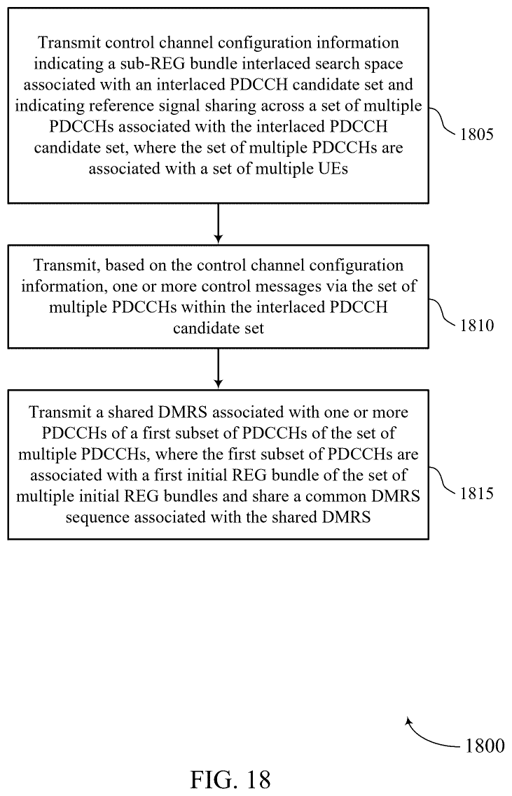

FIG. 18 shows a flowchart illustrating a method 1800 that supports interlaced sub-REG bundles in nested search spaces for PDCCH DMRS sharing in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include transmitting control channel configuration information indicating a sub-REG bundle interlaced search space associated with an interlaced PDCCH candidate set and indicating reference signal sharing across a set of multiple PDCCHs associated with the interlaced PDCCH candidate set, where the set of multiple PDCCHs are associated with a set of multiple UEs. The operations of 1805 may be performed in accordance with examples as disclosed herein. In some examples, aspects of the operations of 1805 may be performed by a configuration information component 1325 as described with reference to FIG. 13.

At 1810, the method may include transmitting, based on the control channel configuration information, one or more control messages via the set of multiple PDCCHs within the interlaced PDCCH candidate set. The operations of 1810 may be performed in accordance with examples as disclosed herein. In some examples, aspects of the operations of 1810 may be performed by a control message transmission component 1330 as described with reference to FIG. 13.

At 1815, the method may include transmitting a shared DMRS associated with one or more PDCCHs of a first subset of PDCCHs of the set of multiple PDCCHs, where the first subset of PDCCHs are associated with a first initial REG bundle of the set of multiple initial REG bundles and share a common DMRS sequence associated with the shared DMRS. The operations of 1815 may be performed in accordance with examples as disclosed herein. In some examples, aspects of the operations of 1815 may be performed by a DMRS transmission component 1340 as described with reference to FIG. 13.

The following provides an overview of aspects of the present disclosure:

Aspect 1: A method for wireless communications by a UE, comprising: receiving control channel configuration information indicating: a sub-REG bundle interlaced search space associated with an interlaced PDCCH candidate set, and reference signal sharing across a plurality of PDCCHs associated with the interlaced PDCCH candidate set; monitoring, based at least in part on the control channel configuration information, the interlaced PDCCH candidate set for a target PDCCH, of the plurality of PDCCHs, that is associated with the UE; and receiving, via the sub-REG bundle interlaced search space and the target PDCCH, a control message.

Aspect 2: The method of aspect 1, wherein the sub-REG bundle interlaced search space is based at least in part on a partition of each initial REG bundle, of a plurality of initial REG bundles of an initial search space associated with an initial PDCCH candidate set, into a plurality of respective sub-REG bundles that are spread in a frequency domain across the plurality of initial REG bundles.

Aspect 3: The method of aspect 2, wherein the initial search space comprises a virtual search space.

Aspect 4: The method of any of aspects 2 through 3, wherein the control channel configuration information further indicates a spreading factor indicating a quantity of sub-REG bundles into which each initial REG bundle is partitioned.

Aspect 5: The method of any of aspects 2 through 4, wherein a first subset of PDCCHs of the plurality of PDCCHs share a common DMRS sequence associated with a shared DMRS, the first subset of PDCCHs are associated with a first initial REG bundle of the plurality of initial REG bundles, and the shared DMRS is embedded within one or more PDCCHs of the first subset of PDCCHs.

Aspect 6: The method of any of aspects 2 through 5, wherein the control channel configuration information further indicates the initial search space, and wherein monitoring the interlaced PDCCH candidate set for the target PDCCH comprises: performing, based at least in part on the initial search space and the sub-REG bundle interlaced search space at least partially overlapping, blind decoding of the initial PDCCH candidate set for the target PDCCH; performing, based at least in part on detection of a shared DMRS during the blind decoding of the initial PDCCH candidate set, channel estimation, wherein the shared DMRS is embedded in the target PDCCH; and performing, based at least in part on the channel estimation, blind decoding of the interlaced PDCCH candidate set for the target PDCCH.

Aspect 7: The method of any of aspects 1 through 6, wherein the sub-REG bundle interlaced search space is based at least in part on a partition of each initial REG bundle, of a plurality of initial REG bundles associated with respective CCEs of an initial PDCCH candidate of a plurality of PDCCH candidates of an initial search space associated with an initial PDCCH candidate set, into a plurality of respective sub-REG bundles that are spread in a frequency domain across the plurality of initial REG bundles.

Aspect 8: The method of any of aspects 1 through 7, wherein the sub-REG bundle interlaced search space is based at least in part on a partition of each initial REG bundle, of a plurality of initial REG bundles, into a plurality of respective sub-REG bundles, an RB cyclic shift is associated with one or more sub-REG bundles of the plurality of respective sub-REG bundles, and different initial REG bundles are associated with different RB cyclic shifts.

Aspect 9: The method of any of aspects 1 through 8, wherein one or more other PDCCHs, of the plurality of PDCCHs, are included in a same REG bundle as the target PDCCH in the sub-REG bundle interlaced search space.

Aspect 10: The method of aspect 9, further comprising: detecting, based at least on one or more sub-REG bundles of the same REG bundle monitored as the target PDCCH, a shared DMRS transmitted by at least one of the one or more other PDCCHs; and performing, based at least in part on detection of the shared DMRS, channel estimation.

Aspect 11: A method for wireless communications by a network entity, comprising: transmitting control channel configuration information indicating a sub-REG bundle interlaced search space associated with an interlaced PDCCH candidate set and indicating reference signal sharing across a plurality of PDCCHs associated with the interlaced PDCCH candidate set, wherein the plurality of PDCCHs are associated with a plurality of UEs; and transmitting, based at least in part on the control channel configuration information, one or more control messages via the plurality of PDCCHs within the interlaced PDCCH candidate set.

Aspect 12: The method of aspect 11, wherein an initial search space is associated with an initial PDCCH candidate set and comprises a plurality of initial REG bundles, and the sub-REG bundle interlaced search space is based at least in part on a partition of each initial REG bundle, of the plurality of initial REG bundles, into a plurality of respective sub-REG bundles that are spread in a frequency domain across the plurality of initial REG bundles.

Aspect 13: The method of aspect 12, wherein the initial search space comprises a virtual search space.

Aspect 14: The method of any of aspects 12 through 13, wherein the control channel configuration information further indicates a spreading factor indicating a quantity of sub-REG bundles into which each initial REG bundle is partitioned.

Aspect 15: The method of any of aspects 12 through 14, further comprising: transmitting a shared DMRS associated with one or more PDCCHs of a first subset of PDCCHs of the plurality of PDCCHs, wherein the first subset of PDCCHs are associated with a first initial REG bundle of the plurality of initial REG bundles and share a common DMRS sequence associated with the shared DMRS.

Aspect 16: The method of any of aspects 12 through 15, wherein the control channel configuration information further indicates the initial search space, and the initial search space and the sub-REG bundle interlaced search space at least partially overlap.

Aspect 17: The method of any of aspects 11 through 16, wherein an initial search space is associated with an initial PDCCH candidate set and comprises a plurality of initial REG bundles associated with respective CCEs of an initial original PDCCH candidate of a plurality of PDCCH candidates, and the sub-REG bundle interlaced search space is based at least in part on a partition of each initial REG bundle, of the plurality of initial REG bundles, into a plurality of respective sub-REG bundles that are spread in a frequency domain across the plurality of initial REG bundles.

Aspect 18: The method of any of aspects 11 through 17, wherein an initial search space is associated with an initial PDCCH candidate set and comprises a plurality of initial REG bundles, the sub-REG bundle interlaced search space is based at least in part on a partition of each initial REG bundle, of the plurality of initial REG bundles, into a plurality of respective sub-REG bundles, an RB cyclic shift is associated with one or more sub-REG bundles of the plurality of respective sub-REG bundles, and different initial REG bundles are associated with different RB cyclic shifts.

Aspect 19: The method of any of aspects 11 through 18, wherein each of the plurality of PDCCHs is included in one or more sub-REG bundles of a same REG bundle in the sub-REG bundle interlaced search space.

Aspect 20: The method of any of aspects 11 through 19, wherein each of the plurality of PDCCHs is included in different REG bundles in the sub-REG bundle interlaced search space.

Aspect 21: A UE for wireless communications, comprising one or more memories storing processor-executable code, and one or more processors coupled with the one or more memories and individually or collectively operable to execute the code to cause the UE to perform a method of any of aspects 1 through 10.

Aspect 22: A UE for wireless communications, comprising at least one means for performing a method of any of aspects 1 through 10.

Aspect 23: A non-transitory computer-readable medium storing code for wireless communications, the code comprising instructions executable by one or more processors to perform a method of any of aspects 1 through 10.

Aspect 24: A network entity for wireless communications, comprising one or more memories storing processor-executable code, and one or more processors coupled with the one or more memories and individually or collectively operable to execute the code to cause the network entity to perform a method of any of aspects 11 through 20.

Aspect 25: A network entity for wireless communications, comprising at least one means for performing a method of any of aspects 11 through 20.

Aspect 26: A non-transitory computer-readable medium storing code for wireless communications, the code comprising instructions executable by one or more processors to perform a method of any of aspects 11 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control channel configuration information indicating:
a sub-resource element group (sub-REG) bundle interlaced search space associated with an interlaced physical downlink control channel (PDCCH) candidate set, and
reference signal sharing across a plurality of PDCCHs associated with the interlaced PDCCH candidate set;
monitor, based at least in part on the control channel configuration information, the interlaced PDCCH candidate set for a target PDCCH, of the plurality of PDCCHs, that is associated with the UE; and
receive, via the sub-REG bundle interlaced search space and the target PDCCH, a control message.

2. The UE of claim 1, wherein the sub-REG bundle interlaced search space is based at least in part on a partition of each initial REG bundle, of a plurality of initial REG bundles of an initial search space associated with an initial PDCCH candidate set, into a plurality of respective sub-REG bundles that are spread in a frequency domain across the plurality of initial REG bundles.

3. The UE of claim 2, wherein the initial search space comprises a virtual search space.

4. The UE of claim 2, wherein the control channel configuration information further indicates a spreading factor indicating a quantity of sub-REG bundles into which each initial REG bundle is partitioned.

5. The UE of claim 2, wherein:
a first subset of PDCCHs of the plurality of PDCCHs share a common demodulation reference signal (DMRS) sequence associated with a shared DMRS,
the first subset of PDCCHs are associated with a first initial REG bundle of the plurality of initial REG bundles, and
the shared DMRS is embedded within one or more PDCCHs of the first subset of PDCCHs.

6. The UE of claim 2, wherein, to monitor the interlaced PDCCH candidate set for the target PDCCH, the one or more processors are individually or collectively operable to execute the code to cause the UE to:
perform, based at least in part on the initial search space and the sub-REG bundle interlaced search space at least partially overlapping, blind decoding of the initial PDCCH candidate set for the target PDCCH;
perform, based at least in part on detection of a shared demodulation reference signal (DMRS) during the blind decoding of the initial PDCCH candidate set, channel estimation, wherein the shared DMRS is embedded in the target PDCCH; and
perform, based at least in part on the channel estimation, blind decoding of the interlaced PDCCH candidate set for the target PDCCH.

7. The UE of claim 1, wherein the sub-REG bundle interlaced search space is based at least in part on a partition of each initial REG bundle, of a plurality of initial REG bundles associated with respective control channel elements (CCEs) of an initial PDCCH candidate of a plurality of PDCCH candidates of an initial search space associated with an initial PDCCH candidate set, into a plurality of respective sub-REG bundles that are spread in a frequency domain across the plurality of initial REG bundles.

8. The UE of claim 1, wherein:
the sub-REG bundle interlaced search space is based at least in part on a partition of each initial REG bundle, of a plurality of initial REG bundles, into a plurality of respective sub-REG bundles,
a resource block (RB) cyclic shift is associated with one or more sub-REG bundles of the plurality of respective sub-REG bundles, and
different initial REG bundles are associated with different RB cyclic shifts.

9. The UE of claim 1, wherein one or more other PDCCHs, of the plurality of PDCCHs, are included in a same REG bundle as the target PDCCH in the sub-REG bundle interlaced search space.

10. The UE of claim 9, wherein the one or more processors are individually or collectively further operable to execute the code to cause the UE to:
detect, based at least on one or more sub-REG bundles of the same REG bundle monitored as the target PDCCH, a shared demodulation reference signal (DMRS) transmitted by at least one of the one or more other PDCCHs; and
perform, based at least in part on detection of the shared DMRS, channel estimation.

11. A network entity, comprising:
one or more memories storing processor-executable code; and
one or more processors coupled with the one or more memories and individually or collectively operable to execute the code to cause the network entity to:
transmit control channel configuration information indicating:
a sub-resource element group (sub-REG) bundle interlaced search space associated with an interlaced physical downlink control channel (PDCCH) candidate set, and
reference signal sharing across a plurality of PDCCHs associated with the interlaced PDCCH candidate set, wherein the plurality of PDCCHs are associated with a plurality of user equipments (UEs); and
transmit, based at least in part on the control channel configuration information, one or more control messages via the plurality of PDCCHs within the interlaced PDCCH candidate set.

12. The network entity of claim 11, wherein:
an initial search space is associated with an initial PDCCH candidate set and comprises a plurality of initial REG bundles, and
the sub-REG bundle interlaced search space is based at least in part on a partition of each initial REG bundle, of the plurality of initial REG bundles, into a plurality of respective sub-REG bundles that are spread in a frequency domain across the plurality of initial REG bundles.

13. The network entity of claim 12, wherein the initial search space comprises a virtual search space.

14. The network entity of claim 12, wherein the control channel configuration information further indicates a spreading factor indicating a quantity of sub-REG bundles into which each initial REG bundle is partitioned.

15. The network entity of claim 12, wherein the one or more processors are individually or collectively further operable to execute the code to cause the network entity to:
transmit a shared demodulation reference signal (DMRS) associated with one or more PDCCHs of a first subset of PDCCHs of the plurality of PDCCHs, wherein the first subset of PDCCHs are associated with a first initial REG bundle of the plurality of initial REG bundles and share a common DMRS sequence associated with the shared DMRS.

16. The network entity of claim 12, wherein:
the control channel configuration information further indicates the initial search space, and
the initial search space and the sub-REG bundle interlaced search space at least partially overlap.

17. The network entity of claim 11, wherein:
an initial search space is associated with an initial PDCCH candidate set and comprises a plurality of initial REG bundles associated with respective control channel elements (CCEs) of an initial PDCCH candidate of a plurality of PDCCH candidates, and
the sub-REG bundle interlaced search space is based at least in part on a partition of each initial REG bundle, of the plurality of initial REG bundles, into a plurality of respective sub-REG bundles that are spread in a frequency domain across the plurality of initial REG bundles.

18. The network entity of claim 11, wherein:
an initial search space is associated with an initial PDCCH candidate set and comprises a plurality of initial REG bundles,
the sub-REG bundle interlaced search space is based at least in part on a partition of each initial REG bundle, of the plurality of initial REG bundles, into a plurality of respective sub-REG bundles,
a resource block (RB) cyclic shift is associated with one or more sub-REG bundles of the plurality of respective sub-REG bundles, and
different initial REG bundles are associated with different RB cyclic shifts.

19. The network entity of claim 11, wherein each of the plurality of PDCCHs is included in one or more sub-REG bundles of a same REG bundle in the sub-REG bundle interlaced search space.

20. The network entity of claim 11, wherein each of the plurality of PDCCHs is included in different REG bundles in the sub-REG bundle interlaced search space.

21. A method for wireless communications by a user equipment (UE), comprising:
receiving control channel configuration information indicating:
a sub-resource element group (sub-REG) bundle interlaced search space associated with an interlaced physical downlink control channel (PDCCH) candidate set, and
reference signal sharing across a plurality of PDCCHs associated with the interlaced PDCCH candidate set;
monitoring, based at least in part on the control channel configuration information, the interlaced PDCCH candidate set for a target PDCCH, of the plurality of PDCCHs, that is associated with the UE; and
receiving, via the sub-REG bundle interlaced search space and the target PDCCH, a control message.

22. The method of claim 21, wherein the sub-REG bundle interlaced search space is based at least in part on a partition of each initial REG bundle, of a plurality of initial REG bundles of an initial search space associated with an initial PDCCH candidate set, into a plurality of respective sub-REG bundles that are spread in a frequency domain across the plurality of initial REG bundles.

23. The method of claim 22, wherein the initial search space comprises a virtual search space.

24. The method of claim 22, wherein the control channel configuration information further indicates a spreading factor indicating a quantity of sub-REG bundles into which each initial REG bundle is partitioned.

25. The method of claim 22, wherein:
a first subset of PDCCHs of the plurality of PDCCHs share a common demodulation reference signal (DMRS) sequence associated with a shared DMRS,
the first subset of PDCCHs are associated with a first initial REG bundle of the plurality of initial REG bundles, and
the shared DMRS is embedded within one or more PDCCHs of the first subset of PDCCHs.

26. The method of claim 22, wherein the control channel configuration information further indicates the initial search space, and wherein monitoring the interlaced PDCCH candidate set for the target PDCCH comprises:
performing, based at least in part on the initial search space and the sub-REG bundle interlaced search space at least partially overlapping, blind decoding of the initial PDCCH candidate set for the target PDCCH;
performing, based at least in part on detection of a shared demodulation reference signal (DMRS) during the blind decoding of the initial PDCCH candidate set, channel estimation, wherein the shared DMRS is embedded in the target PDCCH; and
performing, based at least in part on the channel estimation, blind decoding of the interlaced PDCCH candidate set for the target PDCCH.

27. The method of claim 21, wherein the sub-REG bundle interlaced search space is based at least in part on a partition of each initial REG bundle, of a plurality of initial REG bundles associated with respective control channel elements (CCEs) of an initial PDCCH candidate of a plurality of PDCCH candidates of an initial search space associated with an initial PDCCH candidate set, into a plurality of respective sub-REG bundles that are spread in a frequency domain across the plurality of initial REG bundles.

28. The method of claim 21, wherein:
the sub-REG bundle interlaced search space is based at least in part on a partition of each initial REG bundle, of a plurality of initial REG bundles, into a plurality of respective sub-REG bundles,
a resource block (RB) cyclic shift is associated with one or more sub-REG bundles of the plurality of respective sub-REG bundles, and
different initial REG bundles are associated with different RB cyclic shifts.

29. A method for wireless communications by a network entity, comprising:
transmitting control channel configuration information indicating:
a sub-resource element group (sub-REG) bundle interlaced search space associated with an interlaced physical downlink control channel (PDCCH) candidate set, and
reference signal sharing across a plurality of PDCCHs associated with the interlaced PDCCH candidate set, wherein the plurality of PDCCHs are associated with a plurality of user equipments (UEs); and
transmitting, based at least in part on the control channel configuration information, one or more control messages via the plurality of PDCCHs within the interlaced PDCCH candidate set.

30. The method of claim 29, wherein an initial search space is associated with an initial PDCCH candidate set and comprises a plurality of initial REG bundles, and
wherein the sub-REG bundle interlaced search space is based at least in part on a partition of each initial REG bundle, of the plurality of initial REG bundles, into a plurality of respective sub-REG bundles that are spread in a frequency domain across the plurality of initial REG bundles.
